(19) United States
(12) Patent Application Publication
(10) Pub. No.: US 2016/0096925 A1
(43) Pub. Date: Apr. 7, 2016

(54) COVER MEMBER AND ELECTRONIC DEVICE

(71) Applicants: AKRON POLYMER SYSTEMS INC., Akron, OH (US); SUMITOMO BAKELITE COMPANY LIMITED, Shinagawa-ku (JP)

(72) Inventors: Limin Sun, Copley, OH (US); Dong Zhang, Uniontown, OH (US); Frank W. Harris, Boca Raton, FL (US); Jun Okada, Kobe City (JP); Toshihiko Katayama, Kobe City (JP); Ritsuya Kawasaki, Kobe City (JP); Hideo Umeda, Kobe City (JP); Daisuke Isobe, Kobe City (JP)

(73) Assignees: AKRON POLYMER SYSTEMS INC., Akron, OH (US); SUMITOMO BAKELITE COMPANY LIMITED, Shinagawa-ku (JP)

(21) Appl. No.: 14/873,588

(22) Filed: Oct. 2, 2015

Related U.S. Application Data
(60) Provisional application No. 62/058,774, filed on Oct. 2, 2014.

(51) Int. Cl. C08G 69/32; G06F 3/044; C08G 69/48

(52) U.S. Cl. CPC C08G 69/32; C08G 69/48; G06F 3/044; G06F 2203/04103

(57) ABSTRACT

A cover member includes a base material having a film shape and containing an amorphous aromatic polyamide. Further, it is preferred that the aromatic polyamide contains a carboxyl group. Furthermore, it is preferred that the aromatic polyamide contains a rigid structure in an amount of 85 mol % or more. Moreover, it is preferred that a tensile elastic modulus of the base material is 4 GPa or more. This makes it possible to provide a cover member having a good flatness keeping property and excellent long-term durability, and an electronic device provided with such a cover member and having excellent reliability.

### TECHNICAL FIELD

The present invention relates to a cover member and an electronic device.

### BACKGROUND ART

In recent years, high functionality of various electronic devices such as a cell phone, a music player, a smart phone, a tablet and an electronic paper is progressing. Among the electronic devices, some are known to have a touch panel which can input by touch operation with a finger or the like on a screen thereof.

Specifically, such an electronic device has a display element such as a liquid crystal display or an organic EL display, a touch panel provided on the display element and a cover member provided on the touch panel. An image displayed by the display element passes through the touch panel and the cover member, and then is visually recognized by an operator. If the operator performs the touch operation on the cover member with a finger or the like based on information obtained by the above image, the touch panel detects the above touch operation as, for example, a change of capacitance charge, and then carries out switching of various functions of the electronic device (see patent document 1).

In the electronic device having such a configuration, a cover member formed of a glass material is generally used from the viewpoint of excellent long-term durability. However, in recent years, electronic devices each having a cover member formed of a resin material such as polycarbonate (PC) or polyether sulfone (PES) are proposed for the purpose of reducing a weight thereof and improving flexibility thereof.

In order for the electronic devices each having the cover member formed of such a resin material to have excellent long-term durability, the cover member is required to have an excellent flatness keeping property which can endure the touch operation thereon for a long period of time. However, the cover member formed of the above resin material cannot sufficiently exhibit the flatness keeping property.

Patent document 1: JP-A 2014-146138

### SUMMARY OF THE INVENTION

It is an object of the present invention to provide a cover member having a good flatness keeping property and excellent long-term durability, and an electronic device provided with such a cover member and having excellent reliability.

In order to achieve the objects described above, the present invention includes the following features (1) to (17).

(1) A cover member comprising: a base material having a film shape and containing an amorphous aromatic polyamide.

(2) The cover member according to the above feature (1), wherein the aromatic polyamide contains a carboxyl group.

(3) The cover member according to the above feature (1), wherein the aromatic polyamide contains a rigid structure in an amount of 85 mol % or more.

(4) The cover member according to the above feature (3), wherein the rigid structure is at least one of a repeating unit represented by the following general formula (1) and a repeating unit represented by the following general formula (2):

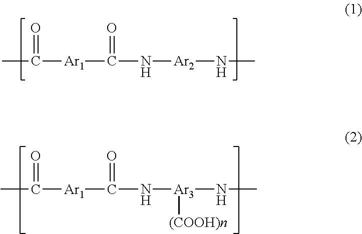

where n is an integer number of 1 to 4, and Ar₁ is selected from the group consisting of the following general formulas (A) and (B):

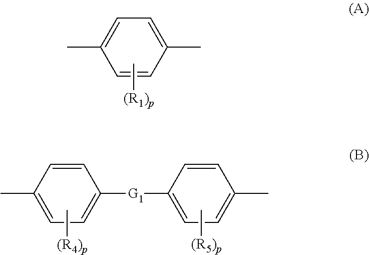

(where p=4; each of R₁, R₄ and R₅ is independently selected from the group consisting of a hydrogen atom, a halogen atom (a fluorine atom, a chlorine atom, a bromine atom, and an iodine atom), an alkyl group, a substituted alkyl group such as a halogenated alkyl group, a nitro group, a cyano group, a thioalkyl group, an alkoxy group, a substituted alkoxy group such as a halogenated alkoxy group, an aryl group, a substituted aryl group such as a halogenated aryl group, an alkyl ester group, a substituted alkyl ester group, and a combination of them; and G₁ is selected from the group consisting of a covalent bond, a CH₂ group, a C(CH₃)₂ group, a C(CF₃)₂ group, a C(CX₃)₂ group (X is a halogen atom.), a CO group, an oxygen atom, a sulfur atom, an SO₂ group, an Si(CH₃)₂ group, a 9,9-fluorene group, a substituted 9,9-fluorene group, and an OZO group (Z is an aryl group or substituted aryl group such as a phenyl group, a biphenyl group, a perfluorobiphenyl group, a 9,9-bisphenyl fluorene group, and a substituted 9,9-bisphenyl fluorene group.).),

where Ar₂ is selected from the group consisting of the following general formulas (C) and (D):

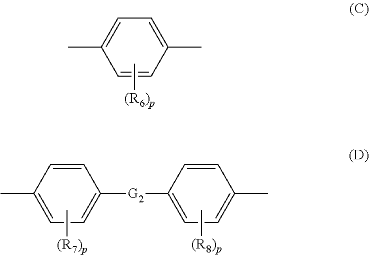

(where p=4; each of R₆, R₇ and R₈ is independently selected from the group consisting of a hydrogen atom, a halogen atom (a fluorine atom, a chlorine atom, a bromine atom, and an iodine atom), an alkyl group, a substituted alkyl group such as a halogenated alkyl group, a nitro group, a cyano group, a thioalkyl group, an alkoxy group, a substituted alkoxy group such as a halogenated alkoxy group, an aryl group, a substituted aryl group such as a halogenated aryl group, an alkyl ester group, a substituted alkyl ester group, and a combination of them; and G₂ is selected from the group consisting of a covalent bond, a CH₂ group, a C(CH₃)₂ group, a C(CF₃)₂ group, a C(CX₃)₂ group (X is a halogen atom.), a CO group, an oxygen atom, a sulfur atom, an SO₂ group, an Si(CH₃)₂ group, a 9,9-fluorene group, a substituted 9,9-fluorene group, and an OZO group (Z is an aryl group or substituted aryl group such as a phenyl group, a biphenyl group, a perfluorobiphenyl group, a 9,9-bisphenyl fluorene group, and a substituted 9,9-bisphenyl fluorene group.).), and

where Ar₃ is selected from the group consisting of the following general formulas (E) and (F):

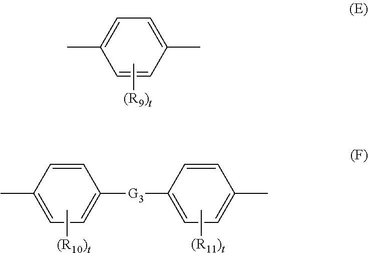

(where t=1 to 3; each of R₉, R₁₀ and R₁₁ is independently selected from the group consisting of a hydrogen atom, a halogen atom (a fluorine atom, a chlorine atom, a bromine atom, and an iodine atom), an alkyl group, a substituted alkyl group such as a halogenated alkyl group, a nitro group, a cyano group, a thioalkyl group, an alkoxy group, a substituted alkoxy group such as a halogenated alkoxy group, an aryl group, a substituted aryl group such as a halogenated aryl group, an alkyl ester group, a substituted alkyl ester group, and a combination of them; and G₃ is selected from the group consisting of a covalent bond, a CH₂ group, a C(CH₃)₂ group, a C(CF₃)₂ group, a C(CX₃)₂ group (X is a halogen atom.), a CO group, an oxygen atom, a sulfur atom, an SO₂ group, an Si(CH₃)₂ group, a 9,9-fluorene group, a substituted 9,9-fluorene group, and an OZO group (Z is an aryl group or substituted aryl group such as a phenyl group, a biphenyl group, a perfluorobiphenyl group, a 9,9-bisphenyl fluorene group, and a substituted 9,9-bisphenyl fluorene group.).).

(5) The cover member according to the above feature (4), wherein the rigid structure contains at least one of a structure derived from 4,4′-diamino-2,2′-bistrifluoromethyl biphenyl (PFMB), a structure derived from terephthaloyl dichloride (TPC), a structure derived from 4,4′-diaminodiphenic acid (DADP), and a structure derived from 3,5-diaminobenzoic acid (DAB).

(6) The cover member according to the above feature (1), wherein the aromatic polyamide contains one or more functional groups that can react with an epoxy group, and

wherein the base material further contains a multifunctional epoxide.

(7) The cover member according to the above feature (6), wherein at least one terminal of the aromatic polyamide is the functional group that can react with the epoxy group.

(8) The cover member according to the above feature (6), wherein the multifunctional epoxide is an epoxide containing two or more glycidyl epoxy groups, or an epoxide containing two or more alicyclic groups.

(9) The cover member according to the above feature (6), wherein the multifunctional epoxide is selected from the group consisting of the following general structures (α) and (β):

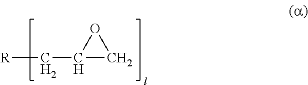

where l is the number of the glycidyl group, and R is selected from the group consisting of the following general formulas:

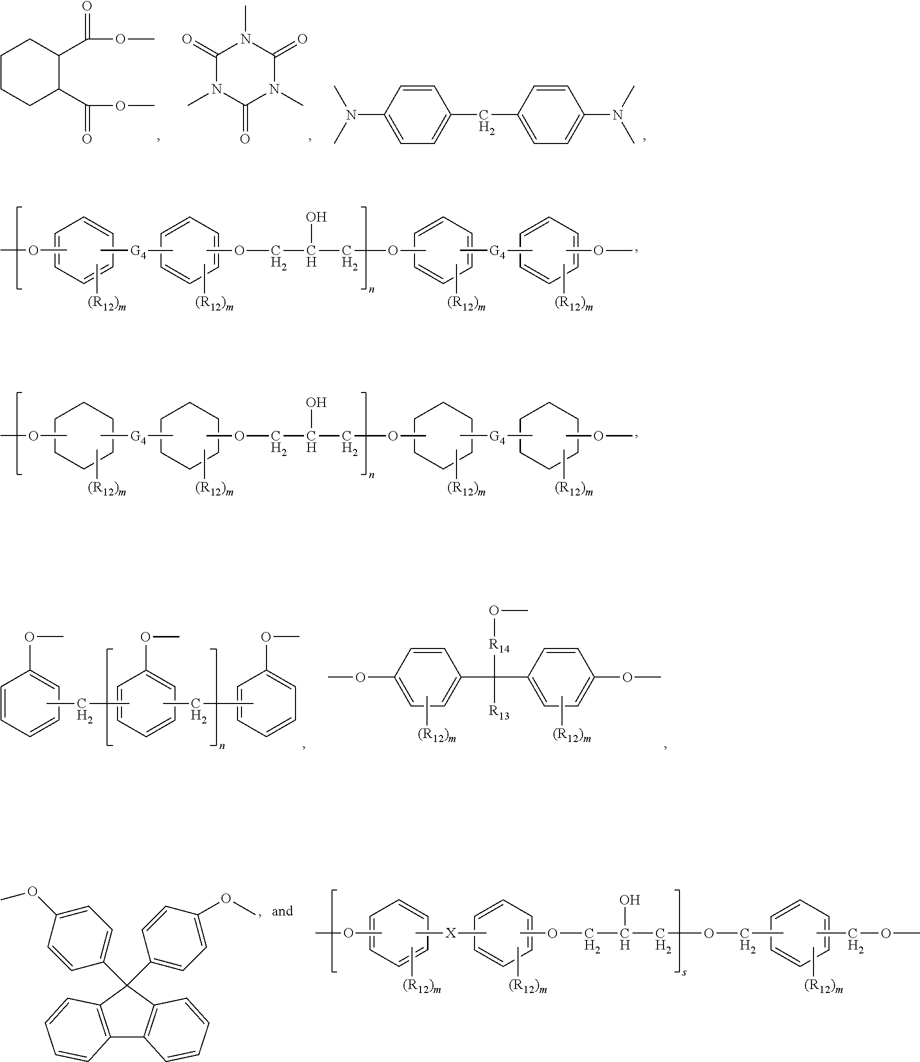

(where m=1 to 4; each of n and s is independently an average number of the units and in the range of 0 to 30; each of R₁₂s is independently selected from the group consisting of a hydrogen atom, a halogen atom (a fluorine atom, a chlorine atom, a bromine atom, and an iodine atom), an alkyl group, a substituted alkyl group such as a halogenated alkyl group, a nitro group, a cyano group, a thioalkyl group, an alkoxy group, a substituted alkoxy group such as a halogenated alkoxy group, an aryl group, a substituted aryl group such as a halogenated aryl group, an alkyl ester group, a substituted alkyl ester group, and a combination of them; G₄ is selected from the group consisting of a covalent bond, a CH₂ group, a C(CH₃)₂ group, a C(CF₃)₂ group, a C(CX₃)₂ group (X is a halogen atom.), a CO group, an oxygen atom, a sulfur atom, an SO₂ group, an Si(CH₃)₂ group, a 9,9-fluorene group, a substituted 9,9-fluorene group, and an OZO group (Z is an aryl group or substituted aryl group such as a phenyl group, a biphenyl group, a perfluorobiphenyl group, a 9,9-bisphenyl fluorene group, and a substituted 9,9-bisphenyl fluorine group.); R₁₃ is a hydrogen atom, or a methyl group; and R₁₄ is a divalent organic group.),

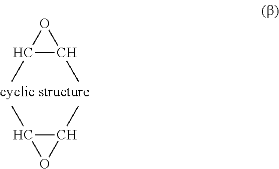

where the cyclic structure is selected from the group consisting of the following general formulas:

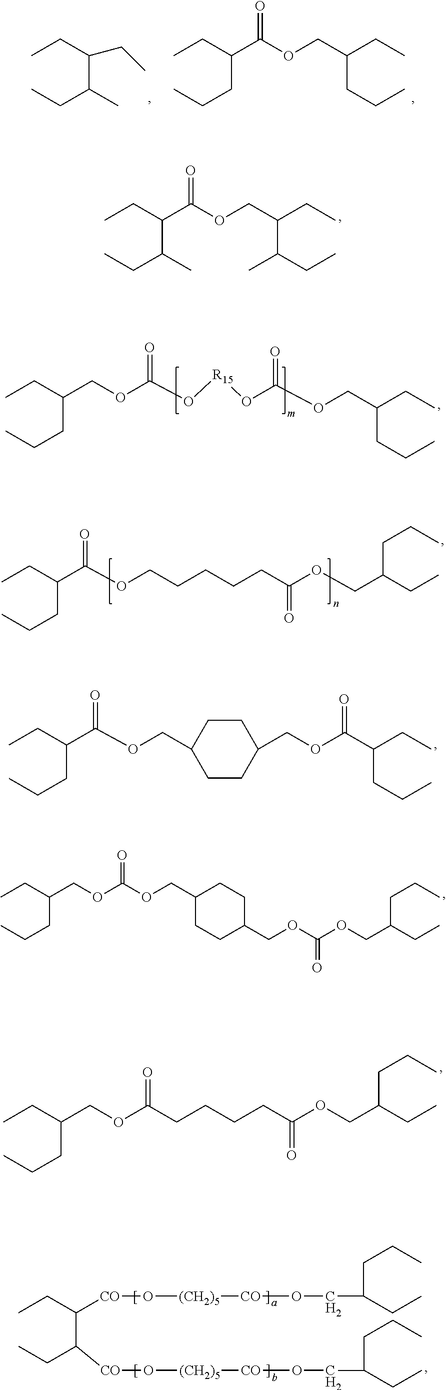

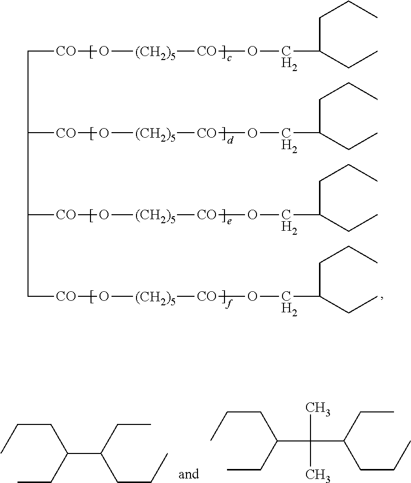

(where R₁₅ is a divalent hydrocarbon group having a carbon number of 2 to 18; the divalent hydrocarbon group is a linear group, a branch group or a group having a cyclic skeleton; each of m and n is independently an integer number of 1 to 30; and each of a, b, c, d, e and f is independently an integer number of 0 to 30.).

(10) The cover member according to the above feature (6), wherein the multifunctional epoxide is selected from the group consisting of the following general structures:

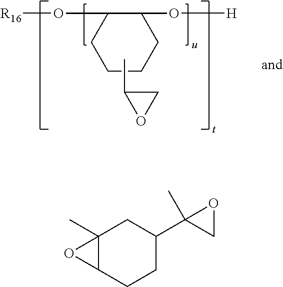

where R₁₆ is a monovalent hydrocarbon group having a carbon number of 2 to 18; the monovalent hydrocarbon group is a linear group, a branch group or a group having a cyclic skeleton; and each of t and u is independently an integer number of 1 to 30.

(11) The cover member according to the above feature (1), wherein a tensile elastic modulus of the base material is 4 GPa or more.

(12) The cover member according to the above feature (1), wherein a loop stiffness value of the base material, which is obtained by using a loop stiffness tester method, is 5 g/25 mm or more.

(13) The cover member according to the above feature (1), wherein a haze value of the base material is 5% or less.

(14) The cover member according to the above feature (1), wherein a total light transmittance of the base material at a wavelength of 400 nm is 65% or more.

(15) The cover member according to the above feature (1), wherein the base material has chemical resistance.

(16) The cover member according to the above feature (1), wherein an average thickness of the base material is in the range of 0.1 to 1,000 μm.

(17) An electronic device comprising:

a touch panel for sensing a change of capacitance charge based on a predetermined operation; and

the cover member provided on the side of one surface of the touch panel and defined by the above feature (1).

### EFFECT OF THE INVENTION

According to the present invention, since a cover member includes a base material having a film shape and containing an amorphous aromatic polyamide, it is possible to improve a flatness keeping property of the cover member. Therefore, by providing such a cover member on the side of one surface of a touch panel, it is possible to keep flatness of a surface of the cover member for a long period of time, even if an operator performs touch operation on the cover member with a finger or the like several times. Namely, it is possible to improve long-term durability of the cover member.

### BRIEF DESCRIPTION OF THE DRAWINGS

FIG. 1 is a perspective view showing an embodiment of a smart phone having a cover member of the present invention.

FIG. 2 is an exploded perspective view of the smart phone shown in FIG. 1.

FIG. 3 is a cross-sectional view of the smart phone shown in FIG. 1 taken along the A-A line.

FIG. 4 is a vertical cross-sectional view to illustrate a method of manufacturing the smart phone shown in FIGS. 1 to 3.

### MODE FOR CARRYING OUT THE INVENTION

Hereinafter, a cover member and an electronic device according to the present invention will be described in detail based on preferred embodiments shown in the accompanying drawings.

First, prior to describing the cover member of the present invention, description will be made on a smart phone in which the electronic device of the present invention is used, that is, a smart phone having the cover member of the present invention which is one example of the electronic device of the present invention.

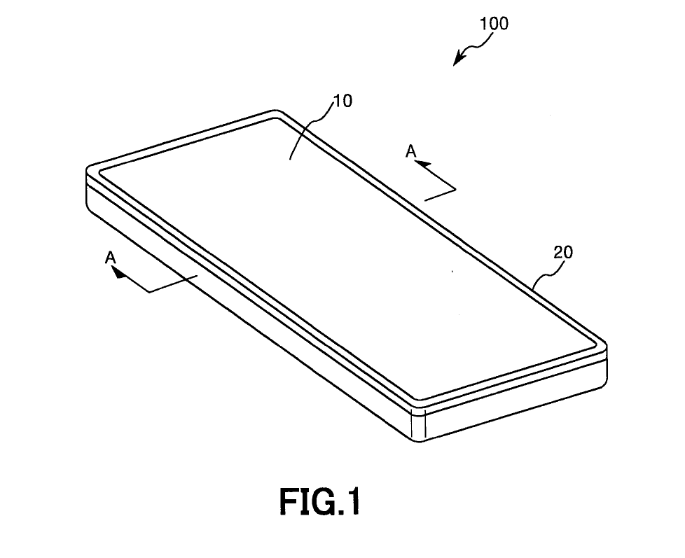

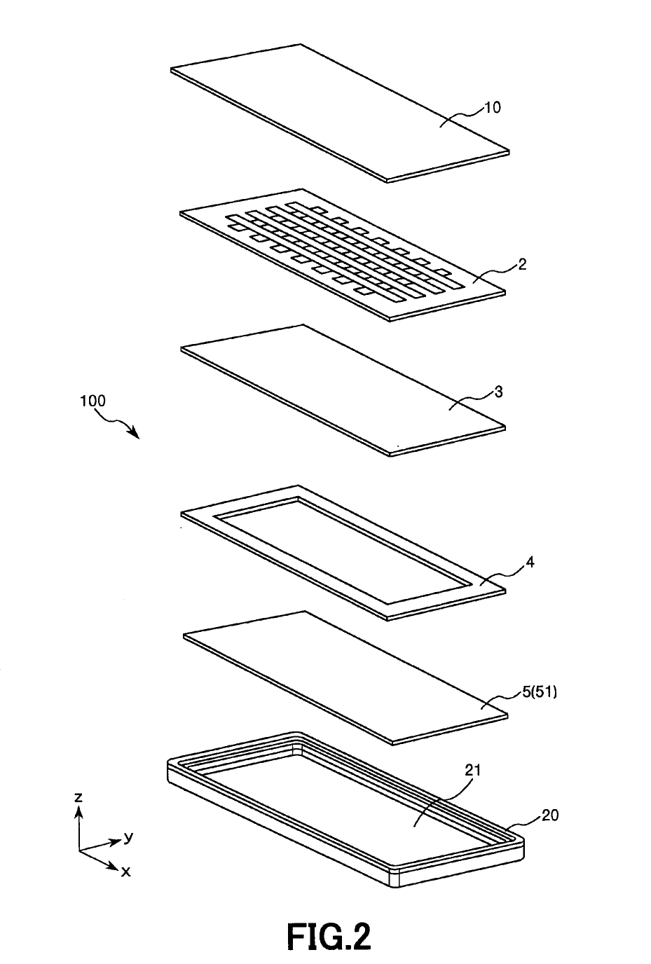

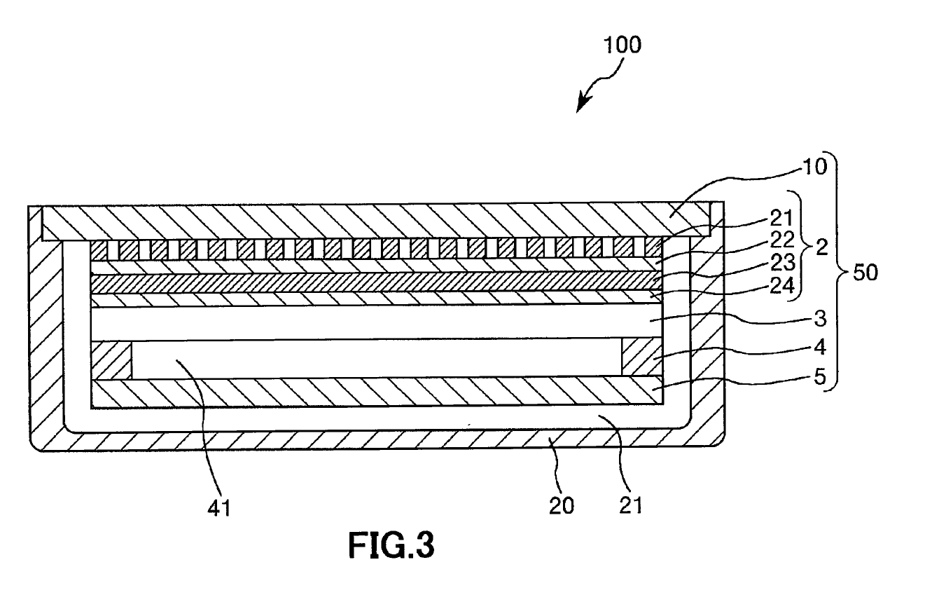

FIG. 1 is a perspective view showing an embodiment of the smart phone having the cover member of the present invention, FIG. 2 is an exploded perspective view of the smart phone shown in FIG. 1, and FIG. 3 is a cross-sectional view of the smart phone shown in FIG. 1 taken along the A-A line. In this regard, in the following description, the front side of paper in FIG. 1 will be referred to as “upper”, and the back side of paper in FIG. 1 will be referred to as “lower”, the upper side in FIG. 2 will be referred to as “upper”, and the lower side in FIG. 2 will be referred to as “lower”.

A smart phone 100 has a cover member 10, a touch panel 2, a display element 3, a cushion member 4, a circuit board 5 and a chassis 20.

The cover member 10 has a plate shape (a film shape) and provided on the side of an upper surface (one surface) of the touch panel 2. This cover member 10 is formed from the cover member of the present invention. Detail description thereof will be made below.

The touch panel 2 includes electrodes 21, a substrate 22, electrodes 23 and a substrate 24, which are laminated together in this order from an upper surface side toward a lower surface side, that is, in a “−Z” axial direction.

The electrodes 21 are formed of, for example, a metal oxide having conductivity and light transmission such as indium tin oxide (ITO), and the whole shapes thereof are of belt-like. The electrodes 21 are provided on an upper surface of the substrate 22 side by side in an x axial direction. Further, the electrodes 23 are formed of, for example, a metal oxide having conductivity and light transmission such as indium tin oxide (ITO), and the whole shape thereof are of belt-like. The electrodes 23 are provided on an upper surface of the substrate 24 side by side in a y axial direction. In this way, the electrodes 21 and the electrodes 23 are intersected with each other at right angles.

The touch panel 2 further includes a connection board not shown in the drawings, one end of this connection board is electrically connected to the respective electrodes 21 and electrodes 23.

In this regard, in this touch panel 2, the substrate 22 on which the electrodes 21 are provided and the substrate 24 on which the electrodes 23 are provided are bonded together, for example, by putting an OCA (an optical transparent double-faced tape) or the like therebetween. Likewise, the touch panel 2 and the cover member 10 are also bonded together, for example, by putting the OCA (the optical transparent double-faced tape) or the like therebetween.

The display element 3 is a liquid crystal display, an organic EL display or the like, of which an upper surface is a display surface. An image displayed by this display element 3 is visually recognized by an operator through the touch panel 2 and the cover member 10.

The cushion member 4 has a square frame shape in the whole shape thereof. Further, the circuit board 5 has a substrate 51, and a control circuit, a detection circuit, a drive circuit and the like, which are not shown in the drawings. The cushion member 4 is arranged between the display element 3 and the circuit board 5 to form a space 41, and the control circuit, the detection circuit, the drive circuit and the like are put into this space 41.

Further, the circuit board 5 is electrically connected to the other end of the connection board included in the touch panel 2. In this way, the detection circuit and the drive circuit are electrically connected to the electrodes 21 and the electrodes 23.

An input device 50 is formed from a laminated body obtained by laminating the above mentioned cover member 10, touch panel 2, display element 3, cushion member 4 and circuit board 5 together. Further, the chassis 20 has a concave portion 21. By putting the input device 50 into this concave portion 21, the smart phone 100 is formed.

According to the smart phone 100 having such a configuration, in a state that the display element 3 displays, for example, a plurality of icons (not shown in the drawings) as an image, when the operator performs touch operation for selecting a desired icon with a finger or the like, that is, when the operator brings the finger or the like into contact with a point of the upper surface of the cover member 10 corresponding to the desired icon, a part of electric field generated between the electrodes 21 and the electrodes 23 each electrically connected to the drive circuit is absorbed by the finger.

The absorption of the electric field by this finger changes the strength of the electric field. This change is detected by the detection circuit electrically connected to the electrodes 21 and the electrodes 23, and then the contact point of the finger or the like is identified by the control circuit based on the above detection result, so that the icon with which the finger or the like has made contact is selected. As a result, the display element 3 displays an image of an application or the like corresponding to such an icon.

(Method of Manufacturing Smart Phone 100)

The smart phone 100 having the configuration as described above can be manufactured as follows.

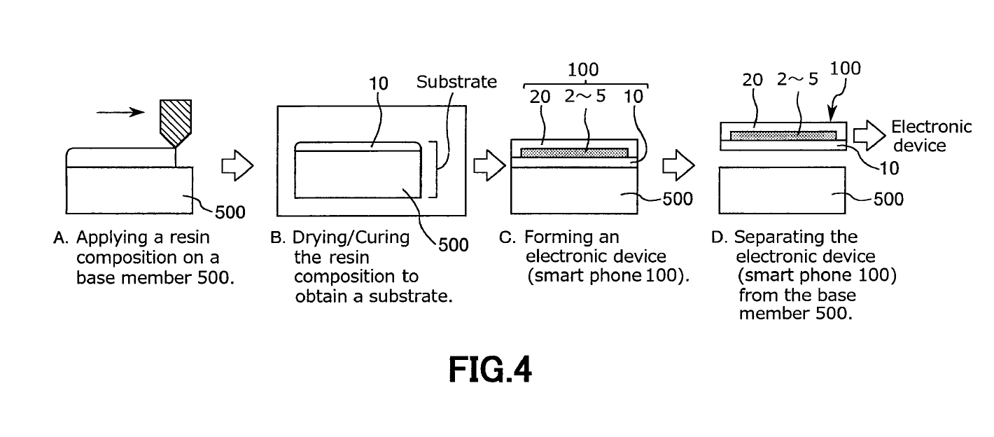

FIG. 4 is a vertical cross-sectional view to illustrate a method of manufacturing the smart phone shown in FIGS. 1 to 3. In this regard, in the following description, the upper side in FIG. 4 will be referred to as “upper”, and the lower side in FIG. 4 will be referred to as “lower”.

[1] First, prepared is a substrate including a plate-like base member 500 (e.g. a glass substrate) having a first surface and a second surface opposite to the first surface; and the cover member (a resin film) 10 provided on the base member 500 on the side of the first surface thereof.

[1-A] First, the base member 500 having the first surface and the second surface, and having light transparency is prepared.

Examples of a constituent material of the base member 500 include a glass, a metal, silicone and the like. These materials may be used alone or may be appropriately used in combination.

[1-B] Next, the cover member 10 is formed on the first surface (one surface) of the base member 500. In this way, the substrate including the base member 500 and the cover member 10 (a laminated composite material shown in FIG. 4) is obtained.

To form this cover member 10, used is a resin composition described below, that is, a resin composition containing an amorphous aromatic polyamide (hereinbelow, the “amorphous aromatic polyamide” is simply referred to as an “aromatic polyamide” on occasion) and a solvent dissolving the aromatic polyamide. By using such a resin composition, the cover member (the resin film) 10 containing the amorphous aromatic polyamide is formed.

Further, examples of a method of forming the cover member 10 include a method in which the resin composition (a varnish) is supplied on the first surface of the base member 500 by using a die coat method as shown in FIG. 4(A), and then the resin composition is dried by, for example, a heat treatment (see FIG. 4(B)).

In this regard, a method of supplying the resin composition on the base member 500 is not limited to the die coat method. Various kinds of liquid-phase film formation methods such as an ink jet method, a spin coat method, a bar coat method, a roll coat method, a wire bar coat method and a dip coat method also can be used.

Further, as described above, the resin composition used for forming the cover member 10 contains the amorphous aromatic polyamide and the solvent dissolving this aromatic polyamide. By using such a resin composition, the cover member 10 containing the amorphous aromatic polyamide can be formed. This resin composition will be described below.

In this regard, from the viewpoint of suppressing warpage deformation of the cover member 10 and/or enhancing dimensional stability thereof, the resin composition is subjected to a heating treatment at a temperature higher by about 40 to 100° C. than a boiling point of the solvent, more preferably at a temperature higher by about 60 to 80° C. than the boiling point of the solvent, and even more preferably at a temperature higher by about 70° C. than the boiling point of the solvent. Further, in one or plurality of embodiments of the present invention, from the viewpoint of suppressing the warpage deformation of the cover member 10 and/or enhancing the dimension stability thereof, the temperature of the heating treatment in this step [1-B] is in the range of 200 to 250° C. Further, also from the viewpoint of suppressing the warpage deformation of the cover member 10 and/or enhancing the dimension stability thereof, a heating time (duration) in this step [1-B] is in the range of more than about 1 minute but less than about 30 minutes.

Further, this step [1-B], in which the cover member 10 is formed on the base member 500, may include a curing treatment process for curing the resin composition after drying the resin composition. A temperature of the curing treatment for the resin composition depends on performance of a heating apparatus, but is preferably in the range of 200 to 420° C., more preferably in the range of 210 to 380° C., and even more preferably in the range of 220 to 300° C. A time of the curing treatment for the resin composition is in the range of 5 to 300 minutes or 30 to 240 minutes.

[2] Next, the touch panel 2 prepared in advance is bonded to an upper surface of the cover member 10.

The cover member 10 and the touch panel 2 can be bonded together, for example, by putting the OCA between the cover member 10 and the touch panel 2, and then pressing them.

For example, the touch panel 2 can be produced as follows.

[2-A] First, metal oxide layers are formed on the substrates 22 and 24, respectively. Thereafter, each metal oxide layer is patterned by an etching method such as wet etching or dry etching using a register layer formed by a photolithography method or the like as a mask. In this way, the respective electrodes 21 and 23 are formed.

[2-B] Next, the substrate 22 on which the electrodes 21 are formed and the substrate 24 on which the electrodes 23 are formed are bonded together by putting the OCA therebetween, and then pressing them. In this way, the touch panel 2 is obtained.

In this regard, this touch panel 2 may be formed by sequentially laminating the respective members 21 to onto the cover member 10 without preparing it in advance.

[3] Next, the display element 3 is bonded to an upper surface of the touch panel 2.

The touch panel 2 and the display element 3 can be bonded together, for example, by using the OCA in the same manner as described in the above mentioned step [2].

[4] Next, the cushion member 4 is bonded to an upper surface of the display element 3.

The display element 3 and the cushion member 4 can be bonded together, for example, by using various kinds of adhesive agents such as an epoxy-based adhesive agent and an acryl-based adhesive agent.

[5] Next, the circuit board 5 is bonded to an upper surface of the cushion member 4.

The cushion member 4 and the circuit board 5 can be bonded together, for example, by using the various kinds of adhesive agents in the same manner as described in the above mentioned step [4].

[6] Next, the respective parts 2 to 5 of the input device 50 other than the cover member 10 are put into the concave portion 21 of the chassis 20, and then a peripheral portion of the cover member 10 and a peripheral portion of the chassis 20 are bonded together.

The peripheral portion of the cover member 10 and the peripheral portion of the chassis 20 can be bonded together, for example, by using the various kinds of adhesive agents in the same manner as described in the above mentioned step [4].

By carrying out the steps [1] to [6] as described above, the smart phone 100, in which a part of the input device 50 is put into the concave portion 21 of the chassis 20, is formed on the base member 500 (see FIG. 4(C)).

[7] Next, the cover member (the resin film) 10 is irradiated with light from the side of the base member 500.

In this way, the cover member 10 is peeled off from the base member 500 at a boundary face between the base member 500 and the cover member 10.

As a result, the smart phone (the electronic device) 100 is separated from the base member 500 (see FIG. 4(D)).

The light, with which the cover member 10 is to be irradiated, is not limited to a specific type, as long as the cover member 10 can be peeled off from the base member 500 at the boundary face between the base member 500 and the cover member 10 by irradiating the cover member 10 with the light, but is preferably laser light. By using the laser light, it is possible to more reliably peel off the cover member 10 from the base member 500 at the boundary face between the base member 500 and the cover member 10.

Further, examples of the laser light include an excimer laser of a pulse oscillator type or a continuous emission type, a carbon dioxide laser, a YAG laser, a YVO₄ laser and the like.

By carrying out the steps [1] to [7] as described above, it is possible to obtain the smart phone 100 peeled off from the base member 500.

In the smart phone 100 having the configuration as described above, if the cover member 10 has a poor flatness keeping property, this causes a problem incapable of sufficiently obtaining long-term durability of the cover member 10 against touch operation on the cover member 10.

For the purpose of solving such a problem, in the present invention, the cover member 10 is formed so as to contain the amorphous aromatic polyamide. By containing the amorphous aromatic polyamide in the cover member 10, the cover member 10 can have an excellent flatness keeping property. This makes it possible to improve the long-term durability of the cover member 10 against the touch operation on the cover member 10.

As described above, the cover member 10 having the above configuration can be formed by using the resin composition containing the amorphous aromatic polyamide and the solvent dissolving this aromatic polyamide. Hereinafter, detailed description will be made on this resin composition.

[Aromatic Polyamide]

The aromatic polyamide is contained in the cover member (the resin film) 10 formed by using the resin composition in an amorphous state. By containing the aromatic polyamide in the cover member 10 formed by using the resin composition in the amorphous state, it is possible to improve the flatness keeping property of the cover member 10. Further, the aromatic polyamide is contained therein in order to effectively carry out peel off of the cover member 10 at the boundary face between the base member 500 and the cover member 10 when the cover member 10 is irradiated with the light.

It is preferred that this aromatic polyamide has a carboxyl group bonding to a main skeleton thereof. This makes it possible to improve chemical resistance (solvent resistance) of not only the aromatic polyamide, but also the formed cover member 10. Therefore, it is possible to expand the range of choices for the solvent used for the resin composition, and a liquid material which would be used during the formation of the respective parts 2 to 5 of the input device 50 (the smart phone 100) onto the cover member 10.

In this regard, in this specification, “to have chemical resistance” means a state that dissolving and swelling of the cover member 10 is not observed after the cover member 10 is immersed into a chemical for 30 minutes at room temperature based on SEMI D19-0305. Examples of the chemical include n-methyl-2-pyrolidone, γ-butyrolactone, 2-propanol, propylene glycol monomethyl ether acetate, ethylene glycol monoethyl ether, 2.38% tris(hydroxymethyl)amine methane, 18% hydrogen chloride, 5% sodium hydroxide, and 5% potassiums hydroxide. These chemicals may be used alone or in combination of two or more.

Further, it is preferred that the aromatic polyamide is a wholly aromatic polyamide. In this case, the aromatic polyamide is more reliably contained in the formed cover member 10 in the amorphous state. In this regard, the wholly aromatic polyamide means an aromatic polyamide in which all amide bonds included in a main chain thereof are bonded to each other through aromatic groups (aromatic rings) without linear or cyclic aliphatic groups.

Such an aromatic polyamide preferably has at least one of repeating units represented by the following general formulas (I) and (II), and more preferably has both the repeating units:

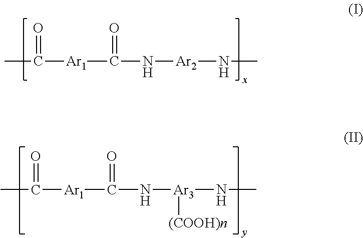

where x is mol % of the repeating unit represented by the general formula (I), n is an integer number of 1 to 4, y is mol % of the repeating unit represented by the general formula (II), Ar₁ is selected from the group consisting of the following the general formulas (III) and (III′):

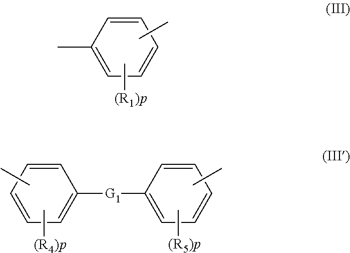

(where p=4; each of R₁, R₄ and R₅ is independently selected from the group consisting of a hydrogen atom, a halogen atom (a fluorine atom, a chlorine atom, a bromine atom, and an iodine atom), an alkyl group, a substituted alkyl group such as a halogenated alkyl group, a nitro group, a cyano group, a thioalkyl group, an alkoxy group, a substituted alkoxy group such as a halogenated alkoxy group, an aryl group, a substituted aryl group such as a halogenated aryl group, an alkyl ester group, a substituted alkyl ester group, and a combination of them; and G₁ is selected from the group consisting of a covalent bond, a CH₂ group, a C(CH₃)₂ group, a C(CF₃)₂ group, a C(CX₃)₂ group (X is a halogen atom.), a CO group, an oxygen atom, a sulfur atom, an SO₂ group, an Si(CH₃)₂ group, a 9,9-fluorene group, a substituted 9,9-fluorene group, and an OZO group (Z is an aryl group or substituted aryl group such as a phenyl group, a biphenyl group, a perfluorobiphenyl group, a 9,9-bisphenyl fluorene group, and a substituted 9,9-bisphenyl fluorene group.).),

where Ar₂ is selected from the group consisting of the following general formulas (IV) and (V):

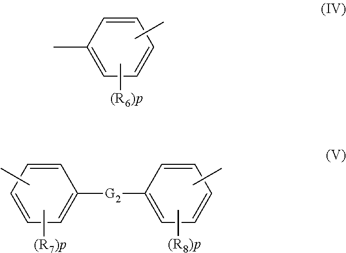

(where p=4; each of R₆, R₇ and R₈ is independently selected from the group consisting of a hydrogen atom, a halogen atom (a fluorine atom, a chlorine atom, a bromine atom, and an iodine atom), an alkyl group, a substituted alkyl group such as a halogenated alkyl group, a nitro group, a cyano group, a thioalkyl group, an alkoxy group, a substituted alkoxy group such as a halogenated alkoxy group, an aryl group, a substituted aryl group such as a halogenated aryl group, an alkyl ester group, a substituted alkyl ester group, and a combination of them; and G₂ is selected from the group consisting of a covalent bond, a CH₂ group, a C(CH₃)₂ group, a C(CF₃)₂ group, a C(CX₃)₂ group (X is a halogen atom.), a CO group, an oxygen atom, a sulfur atom, an SO₂ group, an Si(CH₃)₂ group, a 9,9-fluorene group, a substituted 9,9-fluorene group, and an OZO group (Z is an aryl group or substituted aryl group such as a phenyl group, a biphenyl group, a perfluorobiphenyl group, a 9,9-bisphenyl fluorene group, and a substituted 9,9-bisphenyl fluorene group.).), and

where Ar₃ is selected from the group consisting of the following general formulas (VI) and (VII):

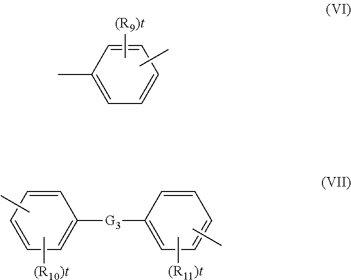

(where t=1 to 3; each of R₉, R₁₀ and R₁₁ is independently selected from the group consisting of a hydrogen atom, a halogen atom (a fluorine atom, a chlorine atom, a bromine atom, and an iodine atom), an alkyl group, a substituted alkyl group such as a halogenated alkyl group, a nitro group, a cyano group, a thioalkyl group, an alkoxy group, a substituted alkoxy group such as a halogenated alkoxy group, an aryl group, a substituted aryl group such as a halogenated aryl group, an alkyl ester group, a substituted alkyl ester group, and a combination of them; and G₃ is selected from the group consisting of a covalent bond, a CH₂ group, a C(CH₃)₂ group, a C(CF₃)₂ group, a C(CX₃)₂ group (X is a halogen atom.), a CO group, an oxygen atom, a sulfur atom, an SO₂ group, an Si(CH₃)₂ group, a 9,9-fluorene group, a substituted 9,9-fluorene group, and an OZO group (Z is an aryl group or substituted aryl group such as a phenyl group, a biphenyl group, a perfluorobiphenyl group, a 9,9-bisphenyl fluorene group, and a substituted 9,9-bisphenyl fluorene group.).).

Further, with regard to the above mentioned aromatic polyamide, in one or plurality of embodiments of the present invention, the repeating units represented by the general formulas (I) and (II) are selected so that the aromatic polyamide is soluble in a polar solvent or a mixed solvent containing one or more polar solvents. In one or plurality of embodiments of the present invention, x in the general formula (I) varies in the range of 90.0 to 99.99 mol %, and y in the general formula (II) varies in the range of 10.0 to 0.01 mol %. In one or plurality of embodiments of the present invention, x in the general formula (I) varies in the range of 90.1 to 99.9 mol %, and y in the general formula (II) varies in the range of 9.9 to 0.1 mol %. In one or plurality of embodiments of the present invention, x in the general formula (I) varies in the range of 90.0 to 99.0 mol %, and y in the general formula (II) varies in the range of 10.0 to 1.0 mol %. In one or plurality of embodiments of the present invention, x in the general formula (I) varies in the range of 92.0 to 98.0 mol %, and y in the general formula (II) varies in the range of 8.0 to 2.0 mol %. In one or plurality of embodiments of the present invention, in the plurality of repeating units represented by the general formulas (I) and (II), Ar₁, Ar₂, and Ar₃ may be the same as or different from each other.

Further, the aromatic polyamide contains a rigid structure (a rigid component) preferably in an amount of 85 mol % or more, and more preferably in an amount of 95 mol % or more with respect to components constituting itself. By containing the rigid structure in such an amount, it is possible to further enhance crystallinity of the aromatic polyamide in the cover member 10. This makes it possible to more improve the flatness keeping property of the obtained cover member 10.

In this regard, in this specification, the rigid structure means a repeating unit (a monomer component) having a linear main skeleton among the repeating units constituting the aromatic polyamide. Specifically, examples of the rigid structure include the repeating units represented by the above mentioned general formulas (I) and (II) in each of which Ar₁ Ar₂ and Ar₃ are as follows, respectively.

Ar₁ is selected from the group consisting of the following general formulas (A) and (B):

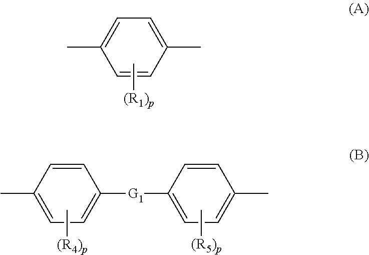

(where p=4; each of R₁, R₄ and R₅ is independently selected from the group consisting of a hydrogen atom, a halogen atom (a fluorine atom, a chlorine atom, a bromine atom, and an iodine atom), an alkyl group, a substituted alkyl group such as a halogenated alkyl group, a nitro group, a cyano group, a thioalkyl group, an alkoxy group, a substituted alkoxy group such as a halogenated alkoxy group, an aryl group, a substituted aryl group such as a halogenated aryl group, an alkyl ester group, a substituted alkyl ester group, and a combination of them; and G₁ is selected from the group consisting of a covalent bond, a CH₂ group, a C(CH₃)₂ group, a C(CF₃)₂ group, a C(CX₃)₂ group (X is a halogen atom.), a CO group, an oxygen atom, a sulfur atom, an SO₂ group, an Si(CH₃)₂ group, a 9,9-fluorene group, a substituted 9,9-fluorene group, and an OZO group (Z is an aryl group or substituted aryl group such as a phenyl group, a biphenyl group, a perfluorobiphenyl group, a 9,9-bisphenyl fluorene group, and a substituted 9,9-bisphenyl fluorene group.).)

Ar₂ is selected from the group consisting of the following general formulas (C) and (D):

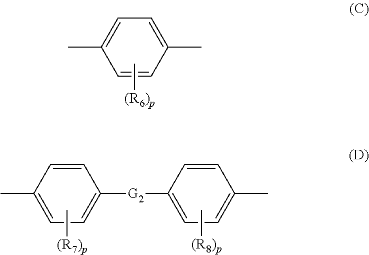

(where p=4; each of R₆, R₇ and R₈ is independently selected from the group consisting of a hydrogen atom, a halogen atom (a fluorine atom, a chlorine atom, a bromine atom, and an iodine atom), an alkyl group, a substituted alkyl group such as a halogenated alkyl group, a nitro group, a cyano group, a thioalkyl group, an alkoxy group, a substituted alkoxy group such as a halogenated alkoxy group, an aryl group, a substituted aryl group such as a halogenated aryl group, an alkyl ester group, a substituted alkyl ester group, and a combination of them; and G₂ is selected from the group consisting of a covalent bond, a CH₂ group, a C(CH₃)₂ group, a C(CF₃)₂ group, a C(CX₃)₂ group (X is a halogen atom.), a CO group, an oxygen atom, a sulfur atom, an SO₂ group, an Si(CH₃)₂ group, a 9,9-fluorene group, a substituted 9,9-fluorene group, and an OZO group (Z is an aryl group or substituted aryl group such as a phenyl group, a biphenyl group, a perfluorobiphenyl group, a 9,9-bisphenyl fluorene group, and a substituted 9,9-bisphenyl fluorene group.).)

Ar₃ is represented by the group consisting of the following general formulas (E) and (F):

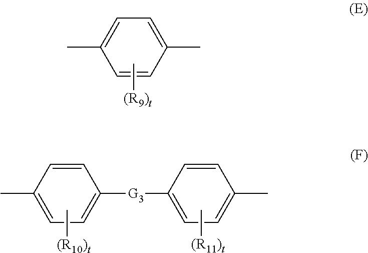

(where t=1 to 3; each of R₉, R₁₀ and R₁₁ is independently selected from the group consisting of a hydrogen atom, a halogen atom (a fluorine atom, a chlorine atom, a bromine atom, and an iodine atom), an alkyl group, a substituted alkyl group such as a halogenated alkyl group, a nitro group, a cyano group, a thioalkyl group, an alkoxy group, a substituted alkoxy group such as a halogenated alkoxy group, an aryl group, a substituted aryl group such as a halogenated aryl group, an alkyl ester group, a substituted alkyl ester group, and a combination of them; and G₃ is selected from the group consisting of a covalent bond, a CH₂ group, a C(CH₃)₂ group, a C(CF₃)₂ group, a C(CX₃)₂ group (X is a halogen atom.), a CO group, an oxygen atom, a sulfur atom, an SO₂ group, an Si(CH₃)₂ group, a 9,9-fluorene group, a substituted 9,9-fluorene group, and an OZO group (Z is an aryl group or substituted aryl group such as a phenyl group, a biphenyl group, a perfluorobiphenyl group, a 9,9-bisphenyl fluorene group, and a substituted 9,9-bisphenyl fluorene group.).)

In addition, concrete examples of Ar₁ include a structure derived from terephthaloyl dichloride (TPC), concrete examples of Ar₂ include a structure derived from 4,4′-diamino-2,2′-bistrifluoromethyl biphenyl (PFMB), and concrete examples of Ar₃ include a structure derived from a structure derived from 4,4′-diaminodiphenic acid (DADP) and a structure derived from 3,5-diaminobenzoic acid (DAB).

Further, a number average molecular weight (Mn) of the aromatic polyamide is preferably 6.0×10⁴ or more, more preferably 6.5×10⁴ or more, more preferably 6.5×10⁴ or more, more preferably 7.0×10⁴ or more, further more preferably 7.5×10⁴ or more, and even more preferably 8.0×10⁴ or more. Furthermore, the number average molecular weight of the aromatic polyamide is preferably 1.0×10⁶ or less, more preferably 8.0×10⁵ or less, further more preferably 6.0×10⁵ or less, and even more preferably 4.0×10⁵ or less. By using the aromatic polyamide satisfying the above condition, it is possible to more easily bring the aromatic polyamide into the amorphous state in the cover member 10.

In this regard, in this specification, the number average molecular weight (Mn) and a weight average molecular weight (Mw) of the aromatic polyamide are measured with a Gel Permeation Chlomatography.

Further, molecular weight distribution of the aromatic polyamide (=Mw/Mn) is preferably 5.0 or less, more preferably 4.0 or less, more preferably 3.0 or less, further more preferably 2.8 or less, further more preferably 2.6 or less, and even more preferably 2.4 or less. In this regard, the molecular weight distribution of the aromatic polyamide is preferably 2.0 or more. By using the aromatic polyamide satisfying the above condition, it is possible to more easily bring the aromatic polyamide into the amorphous state in the cover member 10.

Furthermore, it is preferred that the aromatic polyamide is obtained through a precipitation step after the aromatic polyamide is synthesized. By using the aromatic polyamide obtained through the precipitation step, it is possible to more easily bring the aromatic polyamide into the amorphous state in the cover member 10.

In one or plurality of embodiments of the present invention, one or both of a terminal —COOH group and a terminal —NH₂ group of the aromatic polyamide are end-capped. The end-capping of the terminals is preferable from the viewpoint of improving heat resistance of a layer (namely, the cover member 10). Each terminal which is —NH₂ can be end-capped by the reaction with benzoyl chloride, or each terminal which is —COOH can be end-capped by the reaction with aniline. However, the method of end-capping is not limited thereto.

[Inorganic Filler]

Further, the resin composition may contain an inorganic filler in addition to the aromatic polyamide in such an amount that the cover member 10 is not broken when the cover member 10 is peeled off from the base member 500 in the above mentioned method of manufacturing the smart phone 100. This makes it possible to reduce a coefficient of thermal expansion of the cover member 10.

This inorganic filler is not limited to a specific type, but is preferably constituted of particles or fibers.

Further, a constituent material of the inorganic filler is not limited to a specific type as long as it is an inorganic material. Examples thereof include a metal oxide such as silica, alumina or titanium oxide; a mineral such as mica; a glass; and a mixture of them. These materials may be used alone or in combination of two or more. In this regard, examples of the kind of the glass include E glass, C glass, A glass, S glass, D glass, NE glass, T glass, low permittivity glass and high permittivity glass.

In the case where the inorganic filler is constituted of the fibers, an average fiber diameter of the fibers is preferably in the range of 1 to 1,000 nm. By using the resin composition containing the inorganic filler constituted of the fibers having the above average fiber diameter, it is possible to reliably improve the flatness keeping property of the cover member 10.

Here, each fiber may be formed of a single fiber. In this case, the plurality of single fibers are arranged without orientation and sufficiently separated from each other so as to allow a liquid precursor of the aromatic polyamide to penetrate thereamong. Further, in this case, the average fiber diameter corresponds to an average diameter of the plurality of single fibers. Further, each fiber may be formed of a line of thread in which the plurality of single fibers are bundled. In this case, the average fiber diameter is defined as an average value of diameters of the plurality of lines of thread. Further, from the viewpoint of improving transparency of the cover member 10, it is preferred that the average fiber diameter of the fibers is smaller, and refractive indexes of the aromatic polyamide and the fibers (the inorganic filler) each contained in the resin composition (the aromatic polyamide solution) are closer to each other. For example, in the case where a difference between refractive indexes of a material used for the fibers and the aromatic polyamide at 589 nm is 0.01 or less, it becomes possible to form a cover member 10 having high transparency regardless of the fiber diameters. Further, examples of a method of measuring the average fiber diameter include a method of observing the fibers with an electronic microscope.

Further, in the case where the inorganic filler is constituted of the particles, an average particle size of the particles is preferably in the range of 1 to 1,000 nm. By using the resin composition containing the inorganic filler constituted of the particles having the above average particle size, it is possible to reliably improve the flatness keeping property of the cover member 10.

Here, the average particle size of the particles means an average projection circle equivalent diameter thereof.

A shape of each particle is not limited to a specific type. Examples thereof include a spherical shape, a perfect spherical shape, a rod shape, a plate shape, and a combined shape of them. By using the inorganic filler having such a shape, it is possible to reliably improve the flatness keeping property of the cover member 10.

Further, it is preferred that the average particle size of the particles is smaller, and the refractive indexes of the aromatic polyamide and the particles (the inorganic filler) each contained in the resin composition (the aromatic polyamide solution) are closer to each other. This makes it possible to further improve the transparency of the cover member 10. For example, in the case where a difference between refractive indexes of a material used for the particles and the aromatic polyamide at 589 nm is 0.01 or less, it becomes possible to form the cover member 10 having high transparency regardless of the particle sizes. Further, examples of a method of measuring the average particle size include measurement using a particle size analyzer, and the like.

Furthermore, a ratio of the inorganic filler in a solid matter contained in the resin composition (the aromatic polyamide solution) is not limited to a specific value, but is preferably in the range of 1 to 50 vol %, more preferably in the range of 2 to 40 vol %, and even more preferably in the range of 3 to 30 vol %. In addition, a ratio of the aromatic polyamide in the solid matter contained in the resin composition (the aromatic polyamide solution) is not limited to a specific value, but is preferably in the range of 50 to 99 vol %, more preferably in the range of 60 to 98 vol %, and even more preferably in the range of 70 to 97 vol %.

In this regard, in this specification, the “solid matter” means a component other than the solvent contained in the resin composition. A volume conversion of the solid matter, a volume conversion of the inorganic filler and/or a volume conversion of the aromatic polyamide can be calculated from each component usage at the time of preparing the polymer solution. Alternatively, they can be also calculated by removing the solvent from the resin composition.

[Epoxy Reagent]

Further, the resin composition may optionally contain an epoxy reagent in addition to the aromatic polyamide from the viewpoint of lowering the curing temperature of the resin composition in the above mentioned method of manufacturing the smart phone 100 and improving resistance of the cover member 10 obtained by this resin composition against an organic solvent. Furthermore, it is preferred that the epoxy reagent added into the resin composition is a multifunctional epoxide.

In one or plurality of embodiments of the present invention, the multifunctional epoxide is an epoxide containing two or more glycidyl epoxy groups, or an epoxide containing two or more alicyclic groups.

In one or plurality of embodiments of the present invention, in the case where the resin composition contains the multifunctional epoxide, an amount of the multifunctional epoxide contained therein is in the range of about 0.1 to 10 wt % with regard to a weight of the aromatic polyamide.

In one or plurality of embodiments of the present invention, the curing temperature of the resin composition containing the multifunctional epoxide can be lowered. In one or plurality of embodiments of the present invention not limited, the curing temperature of the resin composition can be set within the range of about 200 to 300° C.

Further, in one or plurality of embodiments of the present invention, the resin composition containing the multifunctional epoxide can impart resistance against an organic solvent to the cover member 10 produced from the resin composition. Examples of such an organic solvent include polar-solvents such as N-methyl-2-pyrolidone (NMP), N,N-dimethyl acetamido (DMAc), dimethyl sulfoxide (DMSO) and γ-butyrolactone.

Both the effect of lowering the curing temperature of the resin composition containing the multifunctional epoxide and the effect of improving the resistance against the organic solvent thereof seem to be obtained from cross-linking of molecules of the aromatic polyamide via the multifunctional epoxide. In one or plurality of embodiments of the present invention, from the viewpoint of enhancing the cross-linking of the molecules of the aromatic polyamide via the multifunctional epoxide, it is preferred that the aromatic polyamide in the resin composition containing the multifunctional epoxide has a free-pendant carboxyl group bonding a main chain thereof or is synthesized by using a diamine monomer having a carboxyl group.

In one or plurality of embodiments of the present invention, the multifunctional epoxide is selected from the group consisting of the following general structures (α) and (β):

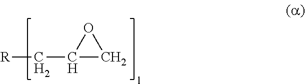

where l is the number of the glycidyl group, and R is selected from the group consisting of the following general formulas:

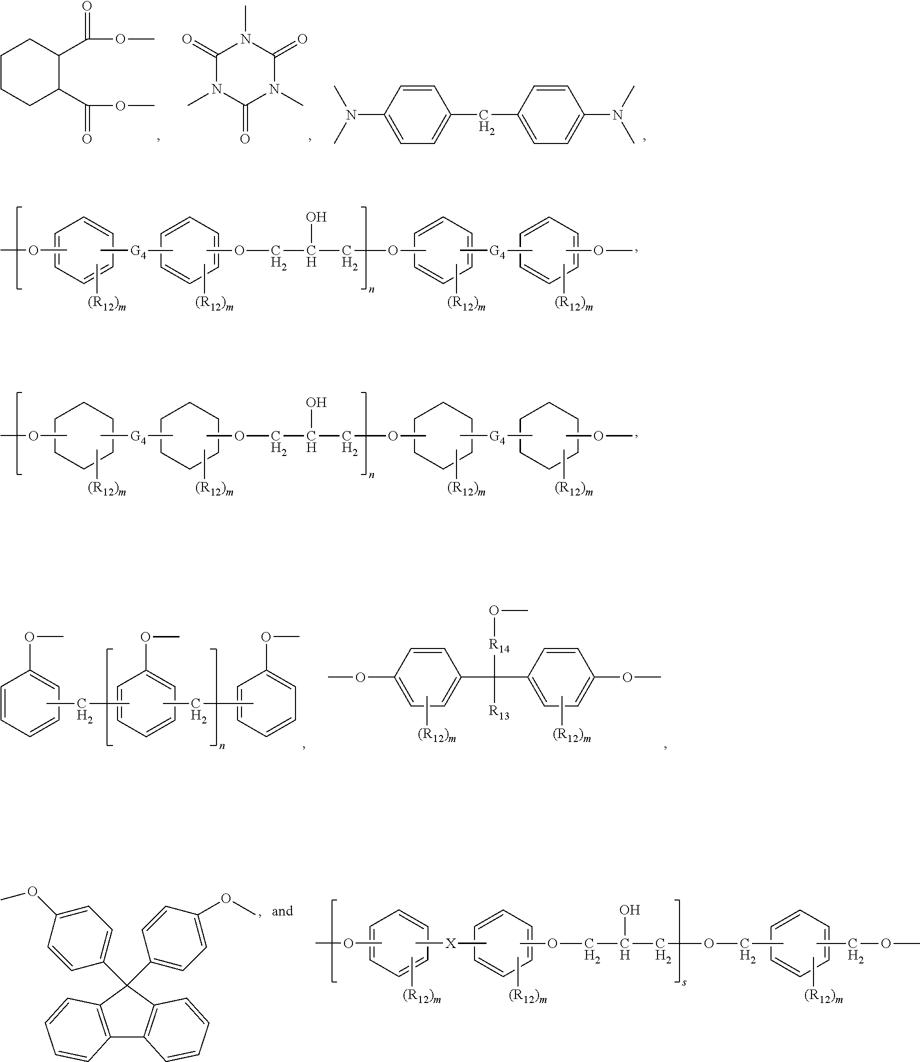

(where m=1 to 4; each of n and s is independently an average number of the units and in the range of 0 to 30; each of R₁₂s is independently selected from the group consisting of a hydrogen atom, a halogen atom (a fluorine atom, a chlorine atom, a bromine atom, and an iodine atom), an alkyl group, a substituted alkyl group such as a halogenated alkyl group, a nitro group, a cyano group, a thioalkyl group, an alkoxy group, a substituted alkoxy group such as a halogenated alkoxy group, an aryl group, a substituted aryl group such as a halogenated aryl group, an alkyl ester group, a substituted alkyl ester group, and a combination of them; G₄ is selected from the group consisting of a covalent bond, a CH₂ group, a C(CH₃)₂ group, a C(CF₃)₂ group, a C(CX₃)₂ group (X is a halogen atom.), a CO group, an oxygen atom, a sulfur atom, an SO₂ group, an Si(CH₃)₂ group, a 9,9-fluorene group, a substituted 9,9-fluorene group, and an OZO group (Z is an aryl group or substituted aryl group such as a phenyl group, a biphenyl group, a perfluorobiphenyl group, a 9,9-bisphenyl fluorene group, and a substituted 9,9-bisphenyl fluorine group.); R₁₃ is a hydrogen atom, or a methyl group; and R₁₄ is a divalent organic group.),

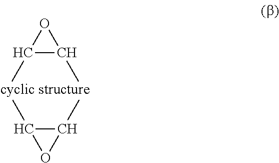

where the cyclic structure is selected from the group consisting of the following general formulas:

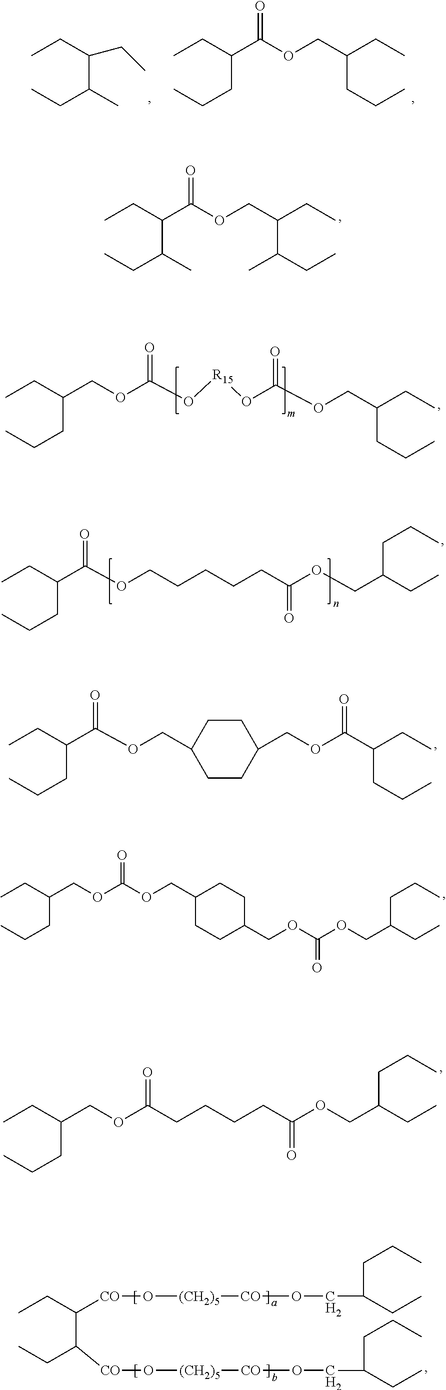

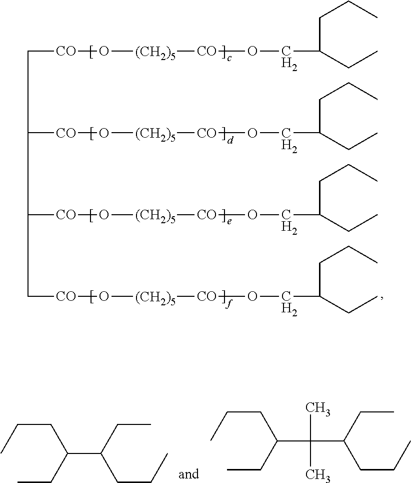

(where R₁₅ is a divalent hydrocarbon group having a carbon number of 2 to 18; the divalent hydrocarbon group is a linear group, a branch group or a group having a cyclic skeleton; each of m and n is independently an integer number of 1 to 30; and each of a, b, c, d, e and f is independently an integer number of 0 to 30.).

In one or plurality of embodiments of the present invention, the multifunctional epoxide is selected from the group consisting of the following general structures:

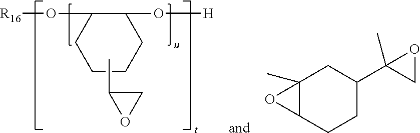

where R₁₆ is a monovalent hydrocarbon group having a carbon number of 2 to 18; the monovalent hydrocarbon group is a linear group, a branch group or a group having a cyclic skeleton; and each of t and u is independently an integer number of 1 to 30.

Further, in one or plurality of embodiments of the present invention, concrete examples of the multifunctional epoxide include:

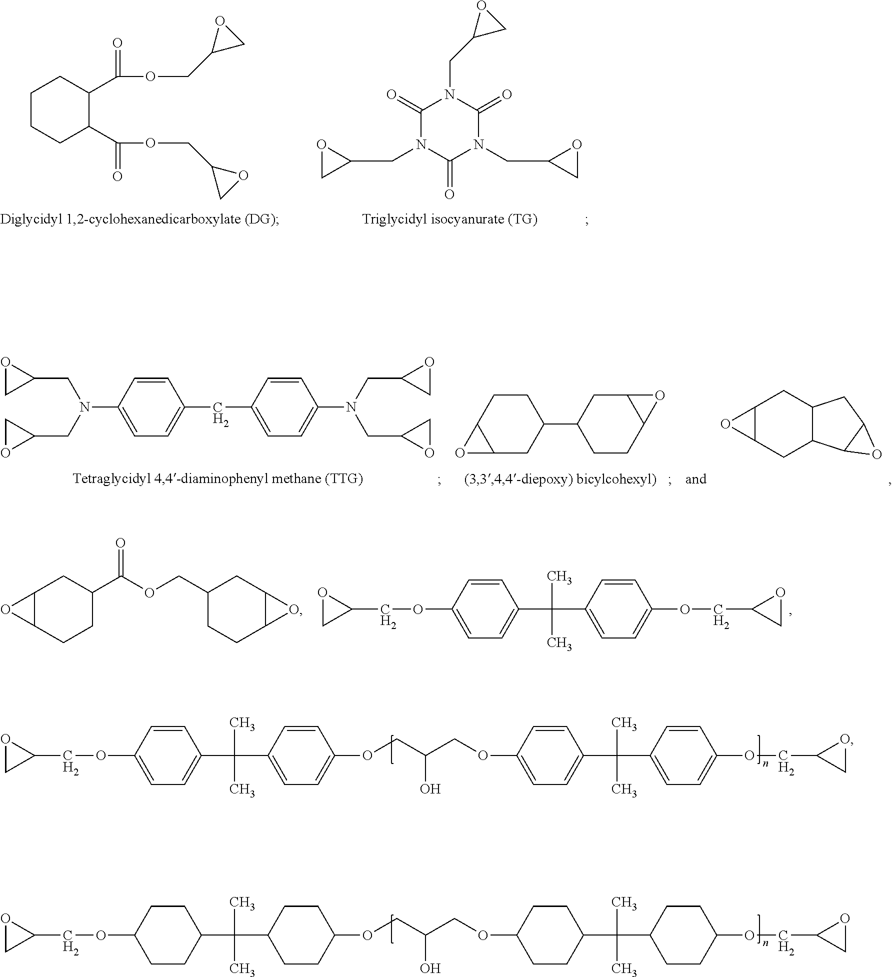

[Other Components]

Furthermore, the resin composition may optionally contain an antioxidant, an ultraviolet absorbing agent, a dye, a pigment, a filler such as another inorganic filler and the like, in such degrees that the function of the cover member 10 is not impaired, especially, the flatness keeping property of the cover member 10 is not lowered.

[Amount of Solid Matter]

An amount of a solid matter contained in the resin composition is preferably 1 vol % or more, more preferably 2 vol % or more, and even more preferably 3 vol % or more. Further, the amount of the solid matter contained in the resin composition is preferably 40 vol % or less, more preferably 30 vol % or less, and even more preferably 20 vol % or less. By setting the amount of the solid matter contained in the resin composition within the above range, it is possible to more easily bring the aromatic polyamide into the amorphous state in the cover member 10 obtained from the resin composition.

[Solvent]

A solvent (a fluxing material) is used to bring the resin composition into a varnish state (a liquidstate) by being selected so as to be capable of dissolving the polymer such as the aromatic polyamide.

In one or plurality of embodiments of the present invention, from the viewpoint of improving solubility of the aromatic polyamide to the solvent, the solvent is preferably a polar solvent or a mixed solvent containing one or more polar solvents. In one or plurality of embodiments of the present invention, from the viewpoint of improving the solubility of the aromatic polyamide to the solvent and enhancing adhesion between the cover member 10 and the base member 500, the solvent is preferably cresol; N,N-dimethyl acetamide (DMAc); N-methyl-2-pyrrolidinone (NMP); dimethyl sulfoxide (DMSO); 1,3-dimethyl-imidazolidinone (DMI); N,N-dimethyl formamide (DMF); butyl cellosolve (BCS); γ-butyrolactone (GBL); a mixed solvent containing at least one of cresol, N,N-dimethyl acetamide (DMAc), N-methyl-2-pyrrolidinone (NMP), dimethyl sulfoxide (DMSO), 1,3-dimethyl-imidazolidinone (DMI), N,N-dimethyl formamide (DMF), butyl cellosolve (BCS) and γ-butyrolactone (GBL); a combination thereof; or a mixed solvent containing at least one of these polar solvents.

[Method of Producing Resin Composition]

The resin composition as described above can be produced by, for example, using a producing method including the following steps (a) to (e).

Hereinafter, description will be made on a case where the aromatic polyamide containing at least one functional group capable of reacting with the epoxy group is used and the resin composition contains the inorganic filler.

However, the resin composition is not limited to a resin composition produced by using the following producing method.

The step (a) is carried out for obtaining a solution (a mixture) by dissolving at least one aromatic diamine in a solvent. The step (b) is carried out for obtaining free hydrochloric acid and an aromatic polyamide by reacting the at least one aromatic diamine with at least one aromatic dicarboxylic acid dichloride in the solution (the solvent). The step (c) is carried out for removing the free hydrochloric acid from the solution by the reaction of the free hydrochloric acid with a trapping reagent. The step (d) is carried out for adding the inorganic filler to the solution. The step (e) is an optional step and carried out for adding the multifunctional epoxide to the solution.

In one or more embodiments of the method for producing the resin composition (the aromatic polyamide solution), examples of the aromatic dicarboxylic acid dichloride include compounds represented by the following general formulas:

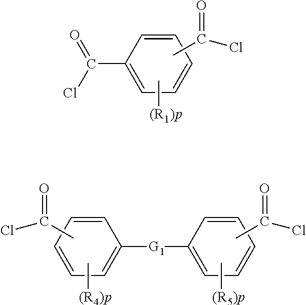

where p=4; each of R₁, R₄ and R₅ is independently selected from the group consisting of a hydrogen atom, a halogen atom (a fluorine atom, a chlorine atom, a bromine atom, and an iodine atom), an alkyl group, a substituted alkyl group such as a halogenated alkyl group, a nitro group, a cyano group, a thioalkyl group, an alkoxy group, a substituted alkoxy group such as a halogenated alkoxy group, an aryl group, a substituted aryl group such as a halogenated aryl group, an alkyl ester group, a substituted alkyl ester group, and a combination of them; and G₁ is selected from the group consisting of a covalent bond, a CH₂ group, a C(CH₃)₂ group, a C(CF₃)₂ group, a C(CX₃)₂ group (X is a halogen atom.), a CO group, an oxygen atom, a sulfur atom, an SO₂ group, an Si(CH₃)₂ group, a 9,9-fluorene group, a substituted 9,9-fluorene group, and an OZO group (Z is an aryl group or substituted aryl group such as a phenyl group, a biphenyl group, a perfluorobiphenyl group, a 9,9-bisphenyl fluorene group, and a substituted 9,9-bisphenyl fluorene group.).

Specifically, examples of the aromatic dicarboxylic acid dichloride as described above include the following compounds.

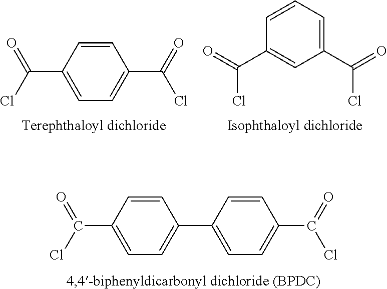

In one or more embodiments of the method for producing the resin composition, examples of the aromatic diamine include compounds represented by the following general formulas:

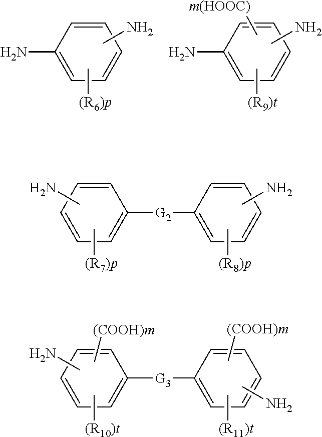

where p=4; m=1 or 2, t=1 to 3; each of R₆, R₇, R₈, R₉, R₁₀ and R₁₁ is independently selected from the group consisting of a hydrogen atom, a halogen atom (a fluorine atom, a chlorine atom, a bromine atom, and an iodine atom), an alkyl group, a substituted alkyl group such as a halogenated alkyl group, a nitro group, a cyano group, a thioalkyl group, an alkoxy group, a substituted alkoxy group such as a halogenated alkoxy group, an aryl group, a substituted aryl group such as a halogenated aryl group, an alkyl ester group, a substituted alkyl ester group, and a combination of them; the respective R₆s may be the same as or different from each other; the respective R₇s may be the same as or different from each other; the respective R₈s may be the same as or different from each other; the respective R₉s may be the same as or different from each other; the respective R₁₀s may be the same as or different from each other; and each of G₂ and G₃ is independently selected from the group consisting of a covalent bond, a CH₂ group, a C(CH₃)₂ group, a C(CF₃)₂ group, a C(CX₃)₂ group (X is a halogen atom.), a CO group, an O atom, an S atom, an SO₂ group, an Si(CH₃)₂ group, a 9,9-fluorene group, a substituted 9,9-fluorene group, and an OZO group (Z is an aryl group or substituted aryl group such as a phenyl group, a biphenyl group, a perfluorobiphenyl group, a 9,9-bisphenyl fluorene group, and a substituted 9,9-bisphenyl fluorene group.).

Specifically, examples of the aromatic diamine as described above include the following compounds.

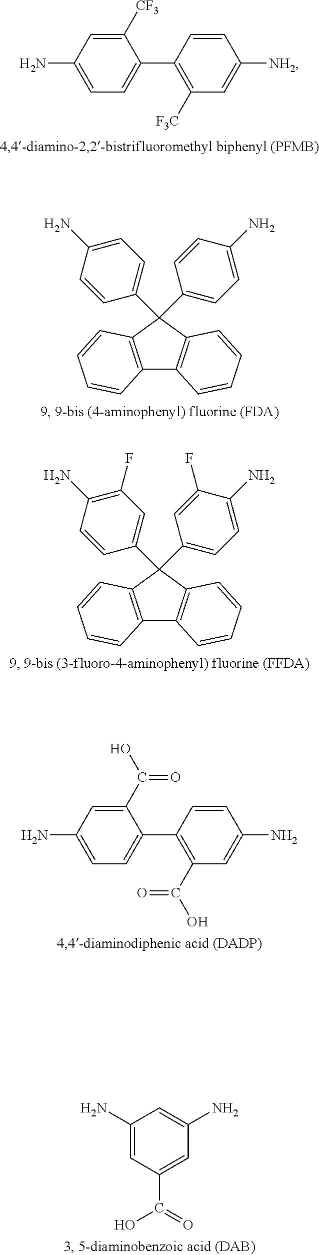 [SMILES: Nc1ccc(-c2ccc(N)cc2C(F)(F)F)c(C(F)(F)F)c1 ; Nc1ccc(C2(c3ccc(N)cc3)c3ccccc3-c3ccccc32)cc1 ; Nc1ccc(C2(c3ccc(N)c(F)c3)c3ccccc3-c3ccccc32)cc1F ; Nc1ccc(-c2ccc(N)cc2C(=O)O)c(C(=O)O)c1 ; Nc1cc(N)cc(C(=O)O)c1]

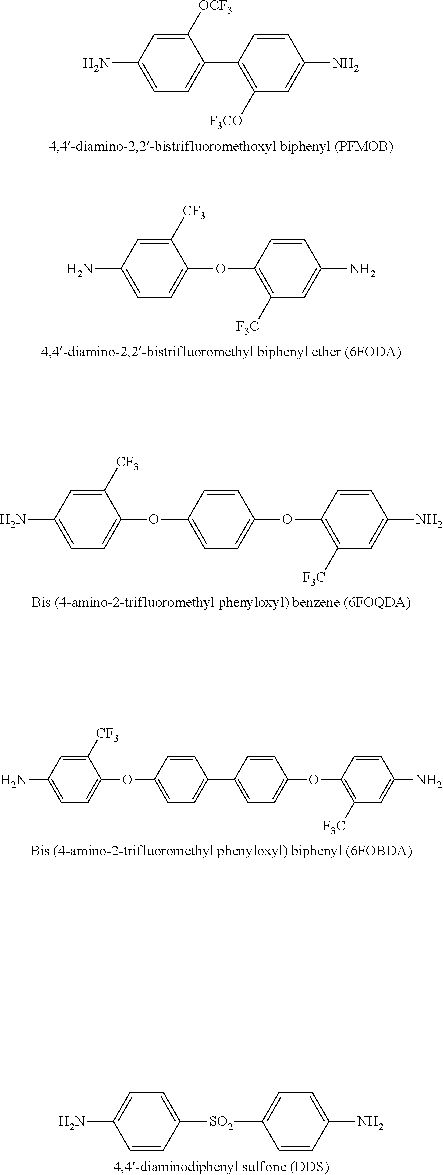 [SMILES: Nc1ccc(-c2ccc(N)cc2OC(F)(F)F)c(OC(F)(F)F)c1 ; Nc1ccc(Oc2ccc(N)cc2C(F)(F)F)c(C(F)(F)F)c1 ; Nc1ccc(Oc2ccc(Oc3ccc(N)cc3C(F)(F)F)cc2)c(C(F)(F)F)c1 ; Nc1ccc(Oc2ccc(-c3ccc(Oc4ccc(N)cc4C(F)(F)F)cc3)cc2)c(C(F)(F)F)c1 ; Nc1ccc(S(=O)(=O)c2ccc(N)cc2)cc1]

In this regard, the diaminodiphenyl sulfone may be the 4,4′-diaminodiphenyl sulfone as represented by the above formula, but may be 3,3′-diaminodiphenyl sulfone or 2,2′-diaminodiphenyl sulfone.

In one or more embodiments of the method for producing the resin composition, an amount of the functional group(s) contained in the aromatic diamine(s) that can react with the epoxy group is greater than about 1 mol % but less than about 10 mol % with respect to a total amount of the aromatic diamine(s). In one or more embodiments of the method for producing the resin composition, the functional group(s) contained in the aromatic diamine that can react with the epoxy group is a carboxyl group. In one or more embodiments of the method for producing the resin composition, any one of the diamines is the 4,4′-diaminodiphenic acid or the 3,5-diaminobenzoic acid. In one or more embodiments of the method for producing the resin composition, the functional group(s) contained in the aromatic diamine(s) that can react with the epoxy group is a hydroxyl group.

In one or more embodiments of the method for producing the resin composition, the aromatic polyamide is synthesized via a condensation polymerization in the solution (the solvent). Here, the hydrochloric acid generated during the reaction is trapped by the trapping reagent such as propylene oxide (PrO).

In one or plurality of embodiments of the present invention, a volatile product is obtained by the reaction of the hydrochloric acid with the trapping reagent.

In one or plurality of embodiments of the present invention, from the viewpoint of appropriately using the resin composition obtained according to this method, the trapping reagent is the propylene oxide. In one or plurality of embodiments of the present invention, the trapping reagent is added to the solution before or during the step (c). By adding the trapping reagent to the solution before or during the step (c), it is possible to reduce increase of a degree of viscosity and generation of condensation of the aromatic polyamide in the solution after the step (c). This makes it possible to improve productivity of the resin composition. These effects become especially remarkable in the case where the trapping reagent is an organic reagent such as the propylene oxide.

In one or plurality of embodiments of the present invention, from the viewpoint of enhancing the heat resistance of the cover member 10, this method further includes the step of end-capping one or both of the terminal —COOH group and the terminal —NH₂ group of the aromatic polyamide. Each terminal which is —NH₂ can be end-capped by the reaction with the benzoyl chloride, or each terminal which is —COOH can be end-capped by the reaction with the aniline. However, the method of end-capping is not limited thereto.

In one or plurality of embodiments of the present invention, the multifunctional epoxide is selected from the group consisting of a phenolic epoxide and a cyclic aliphatic epoxide. In one or plurality of embodiments of the present invention, the multifunctional epoxide is selected from the group consisting of diglycidyl 1,2-cyclohexane carboxylate, triglycidyl isocyanurate, tetraglycidyl 4,4′-diaminophenyl methane, 2,2-bis(4-glycidyl oxyl phenyl) propane, higher molecular weight homologs thereof, novolac epoxide, 7H-[1,2-b:5,6-b′]bisoxireneoctahydro, and epoxycyclohexyl methyl 3,4-epoxycyclohexane carboxylate. In one or plurality of embodiments of the present invention, an amount of the multifunctional epoxide is in the range of about 2 to 10% with respect to a weight of the aromatic polyamide.

In one or plurality of embodiments of the present invention, from the viewpoint of appropriately using the resin composition obtained according to this method, the aromatic polyamide is first isolated from the solution by being precipitated before the inorganic filler and/or the multifunctional epoxide are added thereto, and then re-dissolved to a new solvent.

The precipitation and re-dissolution can be carried out by the normal method. In one or plurality of embodiments of the present invention, the precipitation and re-dissolution are carried out by adding the solution containing the aromatic polyamide to, for example, methanol, ethanol, isopropyl alcohol or the like, to precipitate the aromatic polyamide, collecting and washing the aromatic polyamide, and then dissolving it to a new solvent.

The same solvent described above can be used as the solvent for re-dissolving the aromatic polyamide.

In one or plurality of embodiments of the present invention, from the viewpoint of appropriately using the resin composition obtained according to this method, the resin composition is produced so as not to contain any inorganic salts.

By taking the steps as described above, the resin composition can be produced.

Further, the cover member 10 formed by using the resin composition obtained through the steps described above contains the aromatic polyamide, and this aromatic polyamide is contained in the cover member 10 in the aromatic state. Thus, the flatness keeping property of the cover member 10 becomes excellent. This flatness keeping property can be evaluated based on at least one of a tensile elastic modulus of the cover member 10 and a loop stiffness value thereof obtained by using a loop stiffness tester method.

Here, in the case where the tensile elastic modulus is used for evaluating the flatness keeping property, the tensile elastic modulus of the cover member 10 is preferably 4 GPa or more, more preferably in the range of 5 to 16 GPa, and even more preferably in the range of 6 to 12 GPa. If the tensile elastic modulus of the cover member 10 falls within the above range, it can be considered that the flatness keeping property of the cover member 10 is excellent. In this case, it becomes possible to improve the long-term durability of the cover member 10 against the touch operation on the cover member 10.

In this regard, the tensile elastic modulus of the cover member 10 can be obtained as follows according to JIS K 6251.

First, prepared is a dumbbell-shaped test sample including a parallel portion having a width of 10 mm and a length of 40 mm, and an initial distance between gauge lines (a distance between catching tools) of 90 mm by stamping the cover member 10 with a stamping blade. Next, the dumbbell-shaped test sample has an initial thickness measured, and then is pulled at a speed of 10 mm/min by using an autograph precise universal tester (“autograph AG-X” produced by Shimadzu Corp. Inc.). The elastic modulus can be calculated from an inclination between 0.5% and 1% of stretch. In this regard, the elastic modulus is a value obtained by the following formula: “stretch”=“distance between catching tools after movement”/“initial distance between catching tools)×100.

Further, in the case where the loop stiffness value is used for evaluating the flatness keeping property, the loop stiffness value of the cover member 10 is preferably 5 g/25 mm or more, more preferably in the range of 6 to 13 g/25 mm, and even more preferably in the range of 7 to 11 g/25 mm. If the loop stiffness value of the cover member 10 falls within the above range, it can be considered that the flatness keeping property of the cover member 10 is excellent. In this case, it becomes possible to improve the long-term durability of the cover member 10 against the touch operation on the cover member 10.

In this regard, the loop stiffness value of the cover member 10 can be obtained by using the loop stiffness tester method described below.

First, a cover member 10 having a size of 25 mm×110 mm is prepared as a test sample. Next, performed is a loop stiffness tester method in which a loop having a circumference of 55 mm is formed by pinching both edges of this test sample, and then a load is applied on the loop from the opposite side of the both edges under an atmosphere having a test temperature of 23±5° C. so as to be pushed at a pushing speed of 3.5 mm/sec. A degree of the load pushing the loop such that a vertical inner diameter thereof becomes 5 mm is measured at 0 second, 10 seconds, 30 seconds, 1 minute, 3 minutes and 5 minutes. A maximum value thereof can be defined as a loop stiffness value M [g/25 mm].

Further, a haze value of the cover member 10 is preferably 5% or less, more preferably 3% or less, and even more preferably in the range of 0.01 to 1%. By forming the cover member 10 satisfying the above mentioned relationship, it is possible to reduce flickering of light passing through the cover member 10. This makes it possible to make light extraction efficiency excellent when the light passes through the cover member 10, that is, to improve transmittance of the light passing through the cover member 10.

As a concrete value of the transmittance of the light, a total light transmittance of the cover member 10 at a wavelength of 400 nm is preferably 65% or more, more preferably in the range of 70 to 99%, even more preferably in the range of 75 to 95%, and especially preferably in the range of 80 to 93%. If the total light transmittance of the cover member 10 is set within the above range, it can be considered that the cover member 10 has excellent light extraction efficiency. According to the present invention, since the cover member 10 contains the amorphous aromatic polyamide, it is possible to easily obtain the cover member 10 having the total light transmittance within the above range.

Further, a coefficient of thermal expansion (CTE) of the cover member 10 is preferably 100.0 ppm/K or less, more preferably 80 ppm/K or less, further more preferably 60 ppm/K or less, and even more preferably 40 ppm/K or less. In this regard, the CTE of the cover member 10 can be measured by using a thermal mechanical analyzer (TMA).

By setting the CTE within the above range, it is possible to reliably suppress or prevent warpage of the substrate including the base member 500 and the cover member 10. Therefore, it is possible to improve a yield ratio of the smart phone 100 obtained by using such a substrate.

Further, an average thickness of the cover member 10 is preferably in the range of 0.1 to 1,000 μm, more preferably in the range of 1 to 100 μm, and even more preferably in the range of 5 to 55 μm. By using the cover member 10 having the above average thickness, it is possible for the cover member 10 to reliably provide the function in the smart phone 100 and to reliably suppress or prevent cracks or the like from generating in the cover member 10.

The cover member 10 is composed of the base material (the resin film) containing the amorphous aromatic polyamide in this embodiment, but is not limited thereto. The cover member 10 of the present invention may be composed of such a base material, and a protective layer such as a hard court layer provided on this base material.

Further, the electronic device of the present invention is not only used in the smart phone 100, but also can be used in, for example, a cell phone, a music player, a tablet, an electronic paper and the like.

Furthermore, in the case where the electronic device of the present invention has, for example, an organic EL display as the display element 3, it can be formed by sandwiching a laminated body including the touch panel 2, the display element 3 and the circuit board 5 by the two cover members 10. In this case, if the touch panel 2 and the circuit board 5 each having flexibility are prepared, since the cover member 10 of the present invention has flexibility, the electronic device itself also can have flexibility. In other words, the cover member 10 of the present invention can be used as a film-shaped surface protection member for protecting a surface of the electronic device having the flexibility.

Although the descriptions have been made on the cover member and the electronic device of the present invention based on the embodiments, the present invention is not limited thereto. For example, in the cover member and the electronic device of the present invention, each component may be replaced with an arbitrary component capable of providing the same function. Alternatively, an arbitrary component may be added thereto.

### EXAMPLES

Hereinafter, the present invention will be described based on specific examples in more detail.

### 1. Formation of Cover Member

### Example 1

### Formation of Cover Member

### Resin Film

A resin composition was prepared by co-polymerizing TPC, IPC, PFMB and DAB (in a molar ratio of TPC/IPC/PFMB/DAB=70%/30%/95%/5%) to synthesize an aromatic polyamide, dissolving this aromatic polyamide to a solvent to obtain a solution, and then adding TG (triglycidyl isocyanurate) to the solution in an amount of 1.2 wt % with respect to the aromatic polyamide. Thereafter, 3 cover members (resin films) were formed by using such a resin composition.

Specifically, each cover member was obtained as follows.

First, the resin composition was applied onto a flat glass substrate (10 cm×10 cm, “EAGLE XG” produced by Corning Inc., U.S.A.) by using a spin coat method.

Next, the resin composition was dried at 60° C. for 180 minutes or more. Thereafter, the temperature was raised from 60° C. to 220° C. The resin composition was subjected to a curing treatment by keeping the temperature of 220° C. for 30 minutes under vacuum atmosphere or inert atmosphere. In this way, the cover member was formed on the glass substrate.

Next, a boundary face between the glass substrate and the cover member was irradiated with an excimer laser of a pulse oscillator type from the side of the glass substrate. In this way, the cover member was peeled off from the glass substrate.

In this regard, an average thickness of each of the 3 cover members was measured by using a contact-process digital sensor (“GT2 series” produced by Keyence Corp.), and then an average value thereof was obtained. The average value was 53.4 μm.

### Example 2

3 cover members were obtained in the same manner as Example 1, except that used was a resin composition prepared as follows.

The resin composition was prepared by co-polymerizing TPC, IPC and PFMB (in a molar ratio of TPC/IPC/PFMB=70%/30%/100%) to synthesize an aromatic polyamide, dissolving this aromatic polyamide to a solvent to obtain a solution, and then adding TG (triglycidyl isocyanurate) to the solution in an amount of 5 wt % with respect to the aromatic polyamide.

In this regard, an average thickness of each of the 3 cover members was measured by using the contact-process digital sensor (“GT2 series” produced by Keyence Corp.), and then an average value thereof was obtained. The average value was 50.3 μm.

### Example 3

3 cover members were obtained in the same manner as Example 1, except that used was a resin composition prepared as follows.

The resin composition was prepared by co-polymerizing TPC, PFMB, FDA and DAB (in a molar ratio of TPC/PFMB/FDA/DAB=100%/80%/15%/5%) to synthesize an aromatic polyamide, dissolving this aromatic polyamide to a solvent to obtain a solution, and then adding TG (triglycidyl isocyanurate) to the solution in an amount of 1.1 wt % with respect to the aromatic polyamide.

In this regard, an average thickness of each of the 3 cover members was measured by using the contact-process digital sensor (“GT2 series” produced by Keyence Corp.), and then an average value thereof was obtained. The average value was 48.0 μm.

### Comparative Example 1

Prepared were 3 cover members each composed of a polyether sulphone resin film (“Smilight FS-1300” produced by Sumitomo Bakelite Co., Ltd.).

In this regard, an average thickness of each of the 3 cover members was measured by using the contact-process digital sensor (“GT2 series” produced by Keyence Corp.), and then an average value thereof was obtained. The average value was 51.0 μm.

### Comparative Example 2

Prepared were 3 cover members each composed of a polycarbonate resin film (produced by Sumitomo Bakelite Co., Ltd.).

In this regard, an average thickness of each of the 3 cover members was measured by using the contact-process digital sensor (“GT2 series” produced by Keyence Corp.), and then an average value thereof was obtained. The average value was 50.2 μm.

### 2. Evaluation

The cover members of each of Examples and Comparatives Examples were evaluated according to the following methods.

[Tensile Elastic Modulus]

A tensile elastic modulus of the cover member was obtained as follows. First, a dumbbell-shaped test sample including a parallel portion having a width of 10 mm and a length of 40 mm, and an initial distance between gauge lines (a distance between catching tools) of 90 mm was prepared by stamping the cover member with a stamping blade. Next, the dumbbell-shaped test sample had an initial thickness measured, and then was pulled at a speed of 10 mm/min by using an autograph precise universal tester (“autograph AG-X” produced by Shimadzu Corp. Inc.). The elastic modulus was calculated from an inclination between 0.5% and 1% of stretch. In this regard, the elastic modulus is a value obtained by the following formula: “stretch”=“distance between catching tools after movement”/“initial distance between catching tools)×100.

In this regard, the tensile elastic modulus of the cover member of each of Examples and Comparative Examples was obtained by measuring the tensile elastic modulus of the 3 cover members of each of Examples and Comparative Examples, and then calculating an average value thereof.

[Loop Stiffness Value]

A loop stiffness value M of the cover member was calculated as follows. First, a cover member having a size of 25 mm×110 mm was prepared as a test sample. Next, performed was a loop stiffness tester method in which a loop having a circumference of 55 mm was formed by pinching both edges of this test sample, and then a load was applied on the loop from the opposite side of the both edges under an atmosphere having a test temperature of 23±5° C. so as to be pushed at a pushing speed of 3.5 mm/sec. A degree of the load pushing the loop such that a vertical inner diameter thereof became 5 mm was measured at 0 second, 10 seconds, 30 seconds, 1 minute, 3 minutes and 5 minutes. The loop stiffness value M was obtained from a maximum value thereof.

In this regard, the loop stiffness value of the cover member of each of Examples and Comparative Examples was obtained by measuring the loop stiffness values of the 3 cover members of each of Examples and Comparative Examples, and then calculating an average value thereof.

[Total Light Transmittance (at Wavelength of 400 nm)]

A total light transmittance of the cover member at a wavelength of 400 nm was measured by using a spectrophotometer (“N-670” produced by JASCO).

In this regard, the total light transmittance of the cover member of each of Examples and Comparative Examples was obtained by measuring the total light transmittance of the 3 cover members of each of Examples and Comparative Examples, and then calculating an average value thereof.

[Haze Value]

A haze value of the cover member was obtained as follows. A haze value of the cover member in a D line (a sodium line) was measured by using a haze meter (“NDH-2000” produced by NIPPON DENSHOKU INDUSTRIES CO., LTD.).

In this regard, the haze value of the cover member of each of Examples and Comparative Examples was obtained by measuring the haze values of the 3 cover members of each of Examples and Comparative Examples, and then calculating an average value thereof.

[Chemical Resistance]

Chemical resistance of the cover member was evaluated as follows. Specifically, the cover member was immersed into n-methyl-2-pyrolidone (NMP) for 30 minutes at room temperature, and then existence or non-existence of dissolving and swelling of the cover member was observed with a microscope (magnification: 200 times). Here, if both the cases are not observed, the chemical resistance is evaluated as “good”, whereas if at least one of the cases is observed, the chemical resistance is evaluated as “bad”.

In this regard, the chemical resistance of the 3 cover members of each of Examples and Comparative Examples was evaluated.

The respective results obtained in the cover member of each of Examples and Comparative Examples as described above are shown in Table 1.

TABLE 1

| | | | | Total light | | |
|---|---|---|---|---|---|---|
| | | Tensile | Loop | trans- | | |
| | | elastic | stiffness | mittance | | |
| | Thickness | modulus | value | at 400 nm | Haze | Chemical |
| | μm | GPa | g/25 mm | % | % | resistance |
| Ex. 1 | 53.4 | 7.9 | 8.9 | 81.0 | 0.20 | Good |
| Ex. 2 | 50.3 | 7.8 | 8.6 | 81.3 | 0.50 | Good |
| Ex. 3 | 48.0 | 9.1 | 10.5 | 67.0 | 0.25 | good |
| Com. EX. 1 | 51.0 | 3.2 | 3.4 | 83.2 | 0.04 | Bad |
| Com. EX. 2 | 50.2 | 2.8 | 3.0 | 90.0 | 0.02 | Bad |

As shown in Table 1, the tensile elastic modulus and the loop stiffness value of the cover member of each of Examples were, respectively, 4 GPa or more and 5 g/25 mm or more. These vales mean that the cover member has a high flatness keeping property. The dissolving and the swelling of the cover member of each of Examples were not observed, and thus the cover member exhibited excellent chemical resistance.

On the other hand, the tensile elastic modulus and the loop stiffness value of the cover member of each of Comparative Examples were, respectively, less than 4 GPa and less than 5 g/25 mm. These vales mean that the cover member has a low flatness keeping property. Both the dissolving and swelling of the cover member of each of Comparative Examples were observed, and thus the cover member had poor chemical resistance.

Further, the haze value and the total light transmittance at the wavelength of 400 nm of the cover member of each of Examples were, respectively, 5% or less and 65% or more similar to the cover member of each of Comparative Examples. This means that the cover member of each of Examples exhibited enough optical transparency.

In this way, the cover member of each of Examples had excellent properties (tensile elastic modulus, loop stiffness value, haze value, and total light transmittance at wavelength of 400 nm) in good balance.

What is claimed is:

1. A cover member comprising: a base material having a film shape and containing an amorphous aromatic polyamide.

2. The cover member according to claim 1, wherein the aromatic polyamide contains a carboxyl group.

3. The cover member according to claim 1, wherein the aromatic polyamide contains a rigid structure in an amount of 85 mol % or more.

4. The cover member according to claim 3, wherein the rigid structure is at least one of a repeating unit represented by the following general formula (1) and a repeating unit represented by the following general formula (2): 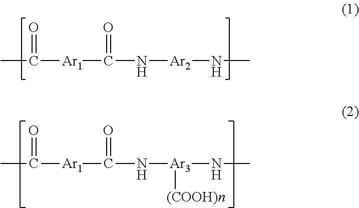
where n is an integer number of 1 to 4, and Ar₁ is selected from the group consisting of the following general formulas (A) and (B): 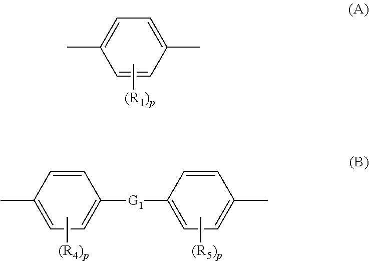
(where p=4; each of R₁, R₄ and R₅ is independently selected from the group consisting of a hydrogen atom, a halogen atom (a fluorine atom, a chlorine atom, a bromine atom, and an iodine atom), an alkyl group, a substituted alkyl group such as a halogenated alkyl group, a nitro group, a cyano group, a thioalkyl group, an alkoxy group, a substituted alkoxy group such as a halogenated alkoxy group, an aryl group, a substituted aryl group such as a halogenated aryl group, an alkyl ester group, a substituted alkyl ester group, and a combination of them; and G₁ is selected from the group consisting of a covalent bond, a CH₂ group, a C(CH₃)₂ group, a C(CF₃)₂ group, a C(CX₃)₂ group (X is a halogen atom.), a CO group, an oxygen atom, a sulfur atom, an SO₂ group, an Si(CH₃)₂ group, a 9,9-fluorene group, a substituted 9,9-fluorene group, and an OZO group (Z is an aryl group or substituted aryl group such as a phenyl group, a biphenyl group, a perfluorobiphenyl group, a 9,9-bisphenyl fluorene group, and a substituted 9,9-bisphenyl fluorene group.).),
where Ar₂ is selected from the group consisting of the following general formulas (C) and (D): 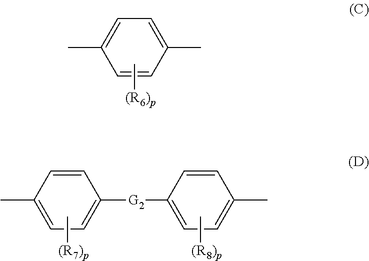
(where p=4; each of R₆, R₇ and R₈ is independently selected from the group consisting of a hydrogen atom, a halogen atom (a fluorine atom, a chlorine atom, a bromine atom, and an iodine atom), an alkyl group, a substituted alkyl group such as a halogenated alkyl group, a nitro group, a cyano group, a thioalkyl group, an alkoxy group, a substituted alkoxy group such as a halogenated alkoxy group, an aryl group, a substituted aryl group such as a halogenated aryl group, an alkyl ester group, a substituted alkyl ester group, and a combination of them; and G₂ is selected from the group consisting of a covalent bond, a CH₂ group, a C(CH₃)₂ group, a C(CF₃)₂ group, a C(CX₃)₂ group (X is a halogen atom.), a CO group, an oxygen atom, a sulfur atom, an SO₂ group, an Si(CH₃)₂ group, a 9,9-fluorene group, a substituted 9,9-fluorene group, and an OZO group (Z is an aryl group or substituted aryl group such as a phenyl group, a biphenyl group, a perfluorobiphenyl group, a 9,9-bisphenyl fluorene group, and a substituted 9,9-bisphenyl fluorene group.).), and
where Ar₃ is selected from the group consisting of the following general formulas (E) and (F): 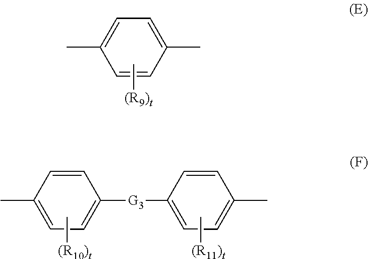
(where t=1 to 3; each of R₉, R₁₀ and R₁₁ is independently selected from the group consisting of a hydrogen atom, a halogen atom (a fluorine atom, a chlorine atom, a bromine atom, and an iodine atom), an alkyl group, a substituted alkyl group such as a halogenated alkyl group, a nitro group, a cyano group, a thioalkyl group, an alkoxy group, a substituted alkoxy group such as a halogenated alkoxy group, an aryl group, a substituted aryl group such as a halogenated aryl group, an alkyl ester group, a substituted alkyl ester group, and a combination of them; and G₃ is selected from the group consisting of a covalent bond, a CH₂ group, a C(CH₃)₂ group, a C(CF₃)₂ group, a C(CX₃)₂ group (X is a halogen atom.), a CO group, an oxygen atom, a sulfur atom, an SO₂ group, an Si(CH₃)₂ group, a 9,9-fluorene group, a substituted 9,9-fluorene group, and an OZO group (Z is an aryl group or substituted aryl group such as a phenyl group, a biphenyl group, a perfluorobiphenyl group, a 9,9-bisphenyl fluorene group, and a substituted 9,9-bisphenyl fluorene group.).).

5. The cover member according to claim 4, wherein the rigid structure contains at least one of a structure derived from 4,4′-diamino-2,2′-bistrifluoromethyl biphenyl (PFMB), a structure derived from terephthaloyl dichloride (TPC), a structure derived from 4,4′-diaminodiphenic acid (DADP), and a structure derived from 3,5-diaminobenzoic acid (DAB).

6. The cover member according to claim 1, wherein the aromatic polyamide contains one or more functional groups that can react with an epoxy group, and
wherein the base material further contains a multifunctional epoxide.

7. The cover member according to claim 6, wherein at least one terminal of the aromatic polyamide is the functional group that can react with the epoxy group.

8. The cover member according to claim 6, wherein the multifunctional epoxide is an epoxide containing two or more glycidyl epoxy groups, or an epoxide containing two or more alicyclic groups.

9. The cover member according to claim 6, wherein the multifunctional epoxide is selected from the group consisting of the following general structures (α) and (β): 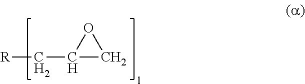
where l is the number of the glycidyl group, and R is selected from the group consisting of the following general formulas: 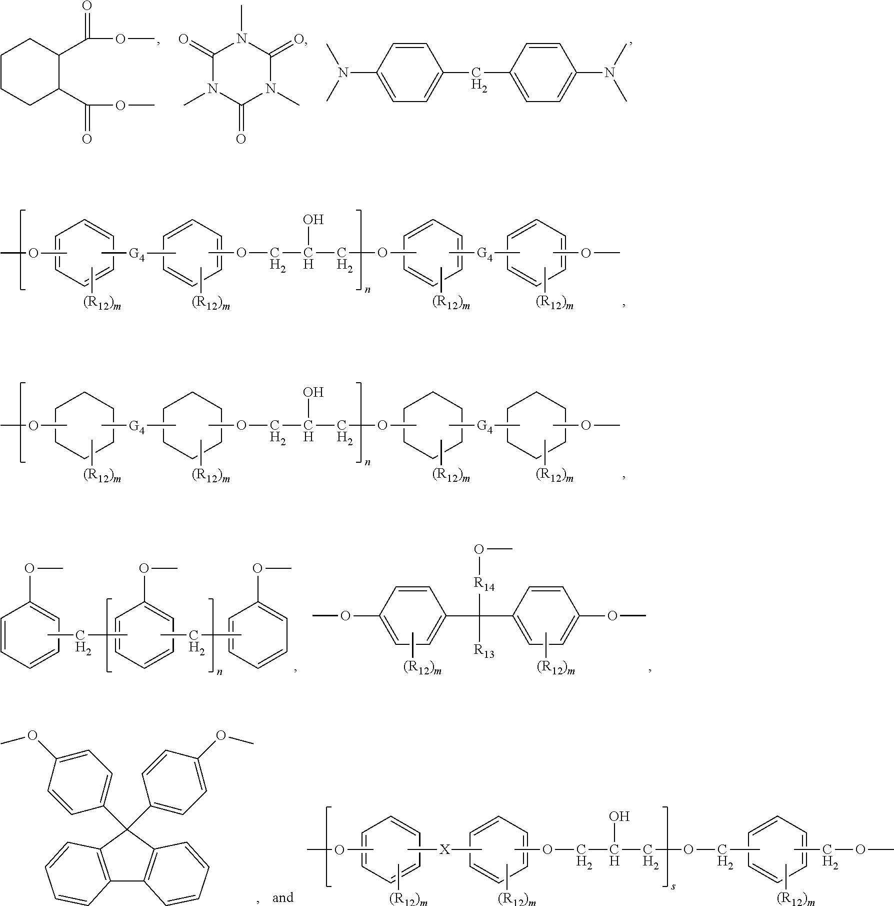
(where m=1 to 4; each of n and s is independently an average number of the units and in the range of 0 to 30; each of R₁₂s is independently selected from the group consisting of a hydrogen atom, a halogen atom (a fluorine atom, a chlorine atom, a bromine atom, and an iodine atom), an alkyl group, a substituted alkyl group such as a halogenated alkyl group, a nitro group, a cyano group, a thioalkyl group, an alkoxy group, a substituted alkoxy group such as a halogenated alkoxy group, an aryl group, a substituted aryl group such as a halogenated aryl group, an alkyl ester group, a substituted alkyl ester group, and a combination of them; G₄ is selected from the group consisting of a covalent bond, a CH₂ group, a C(CH₃)₂ group, a C(CF₃)₂ group, a C(CX₃)₂ group (X is a halogen atom.), a CO group, an oxygen atom, a sulfur atom, an SO₂ group, an Si(CH₃)₂ group, a 9,9-fluorene group, a substituted 9,9-fluorene group, and an OZO group (Z is an aryl group or substituted aryl group such as a phenyl group, a biphenyl group, a perfluorobiphenyl group, a 9,9-bisphenyl fluorene group, and a substituted 9,9-bisphenyl fluorine group.); R₁₃ is a hydrogen atom, or a methyl group; and R₁₄ is a divalent organic group.), 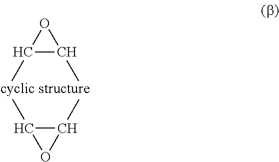
where the cyclic structure is selected from the group consisting of the following general formulas: 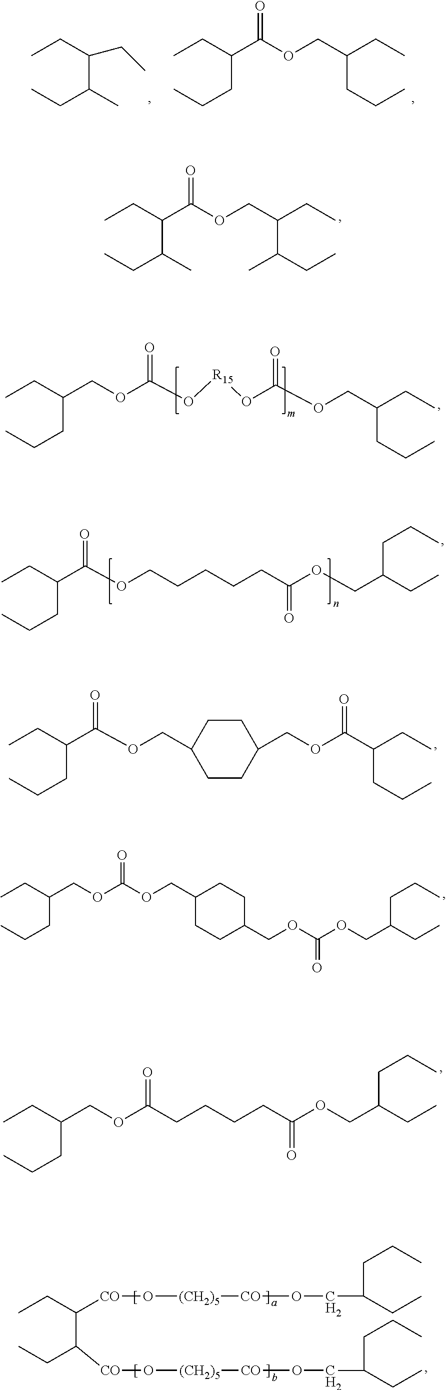 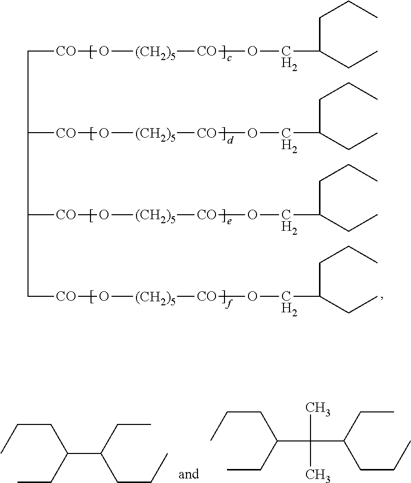
(where R₁₅ is a divalent hydrocarbon group having a carbon number of 2 to 18; the divalent hydrocarbon group is a linear group, a branch group or a group having a cyclic skeleton; each of m and n is independently an integer number of 1 to 30; and each of a, b, c, d, e and f is independently an integer number of 0 to 30.).

10. The cover member according to claim 6, wherein the multifunctional epoxide is selected from the group consisting of the following general structures: 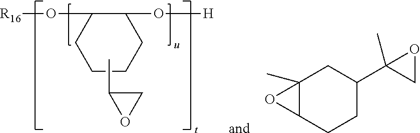
where R₁₆ is a monovalent hydrocarbon group having a carbon number of 2 to 18; the monovalent hydrocarbon group is a linear group, a branch group or a group having a cyclic skeleton; and each of t and u is independently an integer number of 1 to 30.

11. The cover member according to claim 1, wherein a tensile elastic modulus of the base material is 4 GPa or more.

12. The cover member according to claim 1, wherein a loop stiffness value of the base material, which is obtained by using a loop stiffness tester method, is 5 g/25 mm or more.

13. The cover member according to claim 1, wherein a haze value of the base material is 5% or less.

14. The cover member according to claim 1, wherein a total light transmittance of the base material at a wavelength of 400 nm is 65% or more.

15. The cover member according to claim 1, wherein the base material has chemical resistance.

16. The cover member according to claim 1, wherein an average thickness of the base material is in the range of 0.1 to 1,000 μm.

17. An electronic device comprising:
a touch panel for sensing a change of capacitance charge based on a predetermined operation; and
the cover member provided on the side of one surface of the touch panel and defined by claim 1.
